(19) United States
(12) Patent Application Publication
(10) Pub. No.: US 2025/0314514 A1
(43) Pub. Date: Oct. 9, 2025

(54) DOSING HEAD FOR A DOSING SYSTEM

(71) Applicant: VERMES MICRODISPENSING GMBH, Holzkirchen (DE)

(72) Inventor: Andreas STEINHAUSER, München (DE)

(73) Assignee: VERMES MICRODISPENSING GMBH, Holzkirchen (DE)

(21) Appl. No.: 18/865,257

(22) PCT Filed: May 11, 2023
(86) PCT No.: PCT/EP2023/062687

§ 371 Date: Nov. 12, 2024

(30) Foreign Application Priority Data
May 12, 2022 (DE) 10 2022 111 983.1

(51) Int. Cl. G01F 11/00; G01F 11/32

(52) U.S. Cl. CPC G01F 11/006; G01F 11/32

(57) ABSTRACT

The invention relates to a dosing installation (1) comprising at least one dosing device (2), which dosing device (2) has at least one dosing system (3) comprising at least one dosing head (5) for dispensing a dosing material; and at least one change system (6, 6′) assigned to the dosing device (2). The dosing device (2) and/or the change system (6, 6′) and/or the dosing system (3) are designed and can be controlled by a control device (7) in such a way that, in order to form a dosing head (5), at least one first dosing head component (A) can be detachably coupled to at least one second dosing head component (B) in an automated process via the change system (6, 6′). The invention also relates to a change system (6, 6′) and a dosing device (2) for such a dosing installation (1) as well as to a dosing system (3) and a dosing head (5) for a dosing system (3). The invention also relates to a method for coupling at least one first dosing head component (A) to a second dosing head component (B) in an automated manner in order to form a dosing head (5).

The invention relates to a dosing installation comprising at least one dosing device, which dosing device has at least one dosing system for a dosing material comprising at least one dosing head for dispensing the dosing material. The invention further relates to a change system and a dosing device for such a dosing installation as well as a dosing system and a dosing head for a dosing system. The invention further relates to a method for the automated coupling of at least a first dosing head component with a second dosing head component to form a dosing head.

Dosing systems of the type mentioned initially are typically used to apply a medium to be dosed to a target surface in a targeted manner, i.e. at the right time, in the right place and in a precisely dosed amount. In addition to a dosing head, which is used to actually dispense the dosing material, a dosing system usually includes other elements, such as for example, a control for the operation of the dosing head. The dosing material can be dispensed by a dropwise dispensing of a dosing medium or dosing material via a nozzle on the dosing head. As a rule, a dosing head comprises a corresponding dosing valve or is designed as a dosing valve, which is why the terms “dosing head” and “dosing valve” are used synonymously in the description of the invention.

In the context of the so-called “microdosing technology”, it is frequently necessary that very small amounts of a dosing material are placed precisely on the target surface without contact, i.e. without direct contact between the dosing system and a target surface. A typical example of this is the dosing of adhesive dots, solder pastes, etc. when assembling circuit boards or other electronic elements, or the application of converter materials for LEDs.

Such a contactless method is frequently referred to as a “jet process”, whereby a dosing valve operating according to the jet process is referred to as a “jet valve”. The dispensing of (dosing) medium from the jet valve is usually carried out by moving a movable ejection element arranged inside a nozzle of the jet valve at a relatively high speed in an ejection direction towards a nozzle opening, whereby a single drop of the medium is ejected from the nozzle. After completion of such an ejection process, the ejection element is withdrawn again in an opposite direction to eject a subsequent drop.

Alternatively or in addition to a movable ejection element, a nozzle of a jet valve itself can be moved in an ejection or withdrawal position for dispensing the dosing material. To dispense the dosing material, the nozzle and an ejection element arranged inside the nozzle can be moved towards or away from each other in a relative movement, wherein the relative movement can be carried out either solely by a movement of the nozzle or at least partially also by a corresponding movement of the ejection element.

Instead of a jet valve, a dosing system mentioned initially for dispensing the dosing material can also comprise a contact dosing valve. Furthermore, a dosing valve can also be realized as a needle dosing valve. Accordingly, the invention is not limited to a specific type of dosing valve, but can be used with all common dosing valves or dosing systems of the type mentioned initially even if a previously described jet valve is preferred.

When operating a dosing system, it is frequently necessary to replace certain components of the dosing system after a certain period of operation. The reasons for replacing components are numerous and they sometimes depend on the type of dosing valve. For example, before changing the dosing material, it may be necessary to replace the fluid-carrying elements of the dosing valve that come into contact with the dosing material. Depending on the nature of the dosing material, it may be necessary to replace the fluid-carrying elements for cleaning at regular intervals or after a corresponding message from a dosing valve control in order to ensure a consistent dosing result during operation. For dosing systems that are equipped with their own dosing material supply, regular replacement of a dosing material cartridge may be necessary during operation.

A change of components during operation can also be due to a change in the configuration of a dosing system. For example, a configuration of a dosing system can be adjusted via the design of a nozzle and/or an ejection element and/or via the nature of a dosing material in order to obtain a specific dosing pattern. A configuration change can be necessary, for example, if a different (manufacturing) product with a specific dosing pattern is to be manufactured on an installation with a specific dosing material pattern or when different dosing materials or dosing material points of different sizes are required for one and the same product.

Particularly in the case of the jet valves mentioned initially, during operation it is necessary that certain components are exchanged or replaced with new components for maintenance reasons.

In particular, for components that are subject to high wear during operation, regular replacement or replacement as a result of a wear signal is important for a consistent dosing result.

With the dosing systems available today it is certainly fundamentally possible to change or replace certain components or elements. However, a change usually requires that the dosing system is taken out of operation for the duration of the component change and may even have to be removed from a higher-level installation. A change is usually carried out by an operator of the dosing system dismantling the component to be replaced from the dosing system, inserting a new component and then reassembling the dosing system and, if necessary, manually adjusting it. Depending on the design and modularity of the dosing system, changing components can be very time-consuming, which causes an unnecessarily long downtime of the dosing system and thus reduces the efficiency of the dosing system and incurs unnecessary costs.

Particularly in large production plants where a large number of dosing systems are integrated into a higher-level system and are operated jointly by this, changing a component of just one of the dosing systems can lead to a temporary standstill of the entire plant, which has a detrimental effect on the efficiency of the plant.

On the other hand, as stated, a regular exchange or a situation-dependent exchange of certain, for example, worn components of a dosing system during operation is essential to ensure a consistent dosing result.

It is an object of the present invention to provide a dosing installation and the components or dosing installation parts required for operation of the dosing installation by means of which the aforesaid disadvantages can be avoided or at least reduced and by means of which the most efficient operation of a dosing system is made possible.

This object is achieved by a dosing installation according to claim 1, a change system according to claim 5, a dosing device according to claim 6, a dosing head according to claim 7 and a dosing system according to claim 20 as well as by a method according to claim 21.

A dosing installation according to the invention has at least one dosing device, which dosing device has at least one dosing system for a dosing material or a dosing medium, preferably two or more dosing systems.

Within the scope of the invention, a dosing device is to be understood as a higher-level unit or installation which comprises at least (preparation) means so that a dosing material can be dispensed as intended by at least one dosing valve coupled to the dosing device, preferably a dosing system. During operation, i.e. for dispensing the dosing material, the respective dosing systems are preferably detachably coupled to the dosing device, in particular detachably arranged thereon, and are preferably separately controllable. The dosing device can preferably comprise at least one supply device for a proper dosing operation of the coupled dosing systems and/or a control device.

A dosing system according to the invention comprises at least one dosing head or one dosing valve in order to dispense a dosing material onto a substrate in a controlled manner. The dosing valve can be designed according to one of the types mentioned initially, i.e. in particular as a jet valve, and has at least one actuator unit and a fluidic unit coupled thereto during operation and cooperating functionally therewith. A dosing head or a dosing valve comprises at least the components that are involved in the actual dispensing of the dosing material.

In addition to a dosing head, a dosing system has at least one dosing material storage device or dosing material supply and a control device to control the operation of the dosing head. The dosing material storage device and/or the control device can be designed as part of a respective dosing system, e.g. as an incorporated dosing material cartridge. Alternatively or additionally, a dosing head can be coupled during operation with an external dosing material supply and/or with a higher-level control device to form a dosing system. Details on the dosing system will be given subsequently.

According to the invention, a respective dosing system comprises at least one dosing head for dispensing a dosing material from the dosing system. The dosing head or the dosing valve can in particular be designed as a sub-unit of a respective dosing system. Within the scope of the invention, a dosing head (installed as intended) comprises, during operation, at least one actuator unit and a fluidic unit coupled to the actuator unit and cooperating therewith. A dosing head may comprise further elements of a dosing system, as described subsequently. Preferably, a dosing head comprises at least the components of a dosing system which are (mechanically) involved in the dispensing of the dosing material from the dosing system.

The dosing installation according to the invention comprises at least one change system which is at least temporarily assigned to a dosing device during operation. In particular, the change system can be assigned to a specific dosing system, at least temporarily, during operation of the dosing installation.

The change system and/or the dosing device and/or the dosing system are designed and are configured to be controllable by a control device such that for the formation or configuration of a respective dosing head, at least a first dosing head component can be detachably coupled to at least one second dosing head component in an automated process by means of the change system, in particular is reversibly coupled.

An automated process is understood to mean that a coupling process for forming a dosing head can be carried out or is carried out as intended without direct manual involvement of a human being. The individual process steps forming the basis of the automated coupling process and/or the means integrated into the coupling process can be controlled by a control device, in particular by a higher-level control device of the dosing installation, so that a coupling process and/or a decoupling process takes place fully automatically. Details will be given subsequently.

For coupling the first and the second dosing head components to form the dosing head, the change system can temporarily functionally interact with the dosing device and/or with at least parts of a dosing system of the dosing device. In particular, the change system provides means which are designed to, in particular by interaction with the dosing device and/or the dosing system, to form a dosing head by coupling two dosing head components and/or to thereby carry out a decoupling of two dosing head components.

Preferably, a first dosing head component comprises at least one nozzle element of a nozzle. A second dosing head component can be arranged on an associated dosing device and/or on an actuator unit and/or on a fluidic unit. Accordingly, for coupling and/or decoupling two dosing head components the second dosing head component can preferably be arranged directly, but at least indirectly, on a dosing device. This means that in the automated process only one part of a dosing system is changed, whilst another part of the same dosing system is not changed, in particular remains on a dosing device.

The first dosing head component can also be a complete fluidic unit, i.e. including a nozzle, of a dosing system and in the case of the second dosing head component, an actuator unit.

It is also possible that for example, a first dosing head component is designed as a first part of the fluidic unit, e.g. a nozzle, wherein a second dosing head component is designed as a second, different part of the same fluidic unit, e.g. as a fluidic base body. This will be described in more detail subsequently.

The first and the second dosing head components can be coupled to one another in the automated process or are coupled to one another in such a way that a functional dosing head can be formed or is formed. A functional dosing head means that the dosing head e.g. as a subunit of a dosing system, in particular as a component of a higher-level dosing device, is designed such that during operation of the dosing system, a dosing material is dispensed as intended via the dosing head, in particular by means of controlling the dosing head via an associated control device.

According to the invention, the first and the second dosing head components are designed for a detachable, i.e. reversible, coupling. The feature of a “detachable coupling” or “detachable coupling capability” means that the first dosing head component and/or the second dosing head component are designed in such a way that they can be coupled to one another and subsequently decoupled from one another again. This means that two dosing head components, in particular whilst maintaining their respective technical specifications, can be separated from each other again. Such a decoupling process can be carried out in an automated process via a change system according to the invention. In particular, a decoupling of two dosing head components and a subsequent coupling of other dosing head components, i.e. a component change, can be realized in a common process sequence, e.g. as a change process. This will be described subsequently.

Advantageously, the efficiency of the dosing installation can be increased compared to conventional installations by means of a dosing installation according to the invention with a dosing device with a correspondingly constructed dosing system. Due to the modularity of the preferably multiple dosing heads in the dosing installation in interaction with the change system, both the coupling of dosing head components to form a dosing head and the decoupling of the dosing head components of the same dosing head, i.e. the at least partial disassembly of the dosing head, can be carried out in an automated manner. For example, a (decoupled) component can be replaced by a functionally equivalent (new) component in a fully automated process, whereby comparatively little direct manual intervention is required during operation of the dosing installation. For example, a control software for controlling the coupling or decoupling process can be created manually, whereby the actual change process in the dosing installation can then take place without the direct involvement of an operator.

Advantageously, due to the interplay of the modularity of a dosing head, the special coupling mechanism and the change system, an exchange of dosing head components can be carried out more rapidly compared with a manual change, so that the downtimes of the dosing installation can be reduced. In particular, in large production plants with a large number of dosing systems the efficiency of the dosing installation can thus be improved. Furthermore, due to the automated change process, human sources of error when changing dosing system parts can be reduced, which increases production quality.

The invention further relates to a change system for a dosing installation, in particular for a dosing installation according to the invention, wherein the dosing installation has at least one dosing device with at least one dosing system, which dosing system has at least one dosing head, preferably a previously described dosing head. According to the invention, the change system is designed and can be controlled by a control device in such a way that at least a first dosing head component can be detachably coupled to at least one second dosing head component in an automated process via the change system, in particular is reversibly coupled thereto, to form a dosing head.

The change system is preferably designed and can be controlled by a control device such that at least a first dosing head component of a dosing head can be decoupled from at least a second dosing head component in an automated process via the change system.

The invention further relates to a dosing device for a dosing installation, in particular for a dosing installation according to the invention, wherein the dosing device has at least one dosing system with at least one dosing head, preferably a previously described dosing head, and wherein the dosing device is designed and can be controlled by a control device such that, in order to form the dosing head, at least one first dosing head component can be detachably coupled, in particular is reversibly coupled, to at least one second dosing head component in an automated process via a change system of the dosing installation.

The dosing device is preferably designed and can be controlled by a control device such that at least a first dosing head component of a dosing head can be decoupled from at least a second dosing head component in an automated process via a change system.

The invention further relates to a dosing head for a dosing system, in particular for a dosing installation according to the invention, wherein the dosing head has at least one actuator unit and a fluidic unit detachably coupled thereto. In principle, a dosing head according to the invention can also be used in a dosing system independently of a dosing installation and/or independently of a dosing device. However, it is preferred that the dosing head is used as part of a dosing installation since this offers particular advantages.

The actuator unit preferably has at least one actuator for moving an, in particular movable, ejection element of the dosing head for dispensing a dosing material. Preferably, the actuator can be a piezo actuator. Particularly preferably, the actuator can be a pneumatic actuator. A pneumatic actuator can preferably comprise a membrane which can be acted upon and/or deflected by means of a pressure medium in order to thereby move an ejection element in an ejection direction. The fluidic unit comprises at least one feed channel for dosing material and a nozzle for dispensing dosing material from the dosing head. Details on the actuator unit and the fluidic unit will be given subsequently.

According to the invention, a (mounted) dosing head comprises at least a first dosing head component, to which dosing head component a first interface part of an interface is assigned, in particular for forming an interface. Furthermore, the (mounted) dosing head comprises at least one second dosing head component that is configured separately from the first dosing head component. A second interface part of the same interface is assigned to the second dosing head component, in particular for forming the same interface. The first interface part can be formed as part of the first dosing head component, wherein the second interface part can be formed as part of the second dosing head component. Alternatively or additionally, the first interface part can be arranged, at least in sections, on the first dosing head component, wherein the second interface part can be arranged, at least in sections, on the second dosing head component.

According to the invention, the first interface part and/or the second interface part, in particular both interface parts, are designed to detachably couple the first dosing head component to the second dosing head component in an automated process to form the dosing head, thereby forming the interface. The formation of the interface between the first and the second dosing head component is carried out in particular in such a way that the dosing head is correctly configured and functional after coupling of the two dosing head components, whereby during operation the dosing material is dispensed as intended via the dosing head.

In order to couple the two dosing head components, the first dosing head component has a coupling region or an “access region” which is designed to interact with a change system assigned to the dosing head (to be formed) at least temporarily for coupling the first with the second dosing head component in the automated process. The change system is preferably a previously described change system according to the invention of a dosing installation. The change system is assigned to a specific dosing head at least for the period of time during which a dosing head component is changed. The change system can be alternately assigned to different dosing heads and/or different dosing devices.

The coupling region or the access region on the first dosing head component is designed such that the change system can interact with the first dosing head component via the access region, in particular can act thereon in such a way that the first and the second dosing head component are brought into operative contact for coupling. The access region is preferably designed such that the change system can interact with a first dosing head component via the access region in such a way that a decoupling of a first dosing head component from a second dosing head component can also be carried out.

The invention further relates to a dosing system for a dosing device of a dosing installation, in particular for a dosing installation according to the invention. The dosing system has at least one dosing head, in particular a dosing head according to the invention. The dosing system is designed and can be controlled by a control device such that, in order to form the dosing head of the dosing system, at least one first dosing head component can be detachably coupled to at least one second dosing head component in an automated process via a change system of a dosing installation, in particular via a change system according to the invention.

The dosing system is preferably designed to be controllable by a control device such that at least a first dosing head component of a dosing head of the dosing system can be decoupled from at least one second dosing head component in an automated process via a change system.

Advantageously, all previously described components of a dosing installation or dosing installation components are based on the same inventive concept, namely, being able to change a specific component of a dosing head of a dosing system in an automated process.

Consequently, the same advantageous effects that have been described for the dosing installation according to the invention also result in a corresponding manner for a dosing device, a change system, a dosing system and a dosing head.

In a method according to the invention for the automated coupling of at least a first dosing head component with a second dosing head component to form a dosing head of a dosing system, preferably a dosing system according to the invention and/or a dosing system for a dosing installation according to the invention, the automated coupling preferably comprises at least one change of at least one dosing head component. Preferably, the automated coupling can take place during operation of a dosing installation, in particular whilst at least one other dosing system of the same dosing installation continues the dosing operation.

The method may comprise at least the following steps:

In an optional step, at least one interface of a (mounted) dosing head, which interface has a first interface part and a second interface part, can be transferred to a transfer state of the interface in order to enable an automated change of a first dosing head component which comprises the first interface part. Preferably, the transfer state can be brought about by de-energizing and/or de-pressurizing at least some interface elements of at least one interface part. Preferably, a supply coupling can be de-energized and/or depressurized. In particular, the transfer state of the interface can be established via a control of a control device assigned to the dosing system, preferably a higher-level control device.

In an optional step, the first dosing head component can be transferred to a change system, preferably using a coupling region of the first dosing head component assigned to the change system. Preferably, the first dosing head component can be transferred into a movable change manipulator.

In an optional step, the interface can be transferred to a decoupling state, preferably by means of a control device assigned to the dosing system, preferably a higher-level control device assigned to the dosing system. To transfer to the decoupling state, a preferably mechanical coupling between the first interface part and the second interface part can be released.

In an optional step, the first (detached) dosing head component with the first interface part can be transferred into a magazine, preferably into a magazine of the change system. Preferably, the transfer can be carried out by means of a movable component of the change system, in particular via a movable change manipulator.

The optional process steps described above are preferably carried out if a dosing head component is to be replaced, i.e. a dosing head component is replaced directly or in the same process sequence by another dosing head component having the same function. In this respect, the procedure can then be referred to as a combined decoupling/coupling procedure or, in short, as a “change procedure”. The previously described steps do not necessarily have to be carried out in the said sequence although several steps can be carried out substantially simultaneously or individual steps can be omitted.

In any case, the method according to the invention comprises the method steps described hereinafter. If the procedure is carried out as a “change procedure”, these process steps can substantially follow on directly from the decoupling steps described above.

Alternatively, the following steps can be performed independently of the previous optional steps, e.g. when a dosing head (in a certain form) is configured for the first time or after a dosing system has not been in operation for a long time or has been without a functional dosing head.

Firstly, a first dosing head component, to which a first interface part is assigned, is provided. Preferably, provision is made by means of a change system. Provision means at least that the change system has access to a first dosing head component and in particular can interact with a first dosing head component.

Thereafter, using the change system, the first interface part, which is assigned to the first dosing head component, is brought together with a complementary second interface part, which is assigned to a second dosing head component, which dosing head component is preferably arranged on a dosing device, to form an interface.

At least one interface element of the interface is engaged in order to detachably or reversibly couple the first dosing head component via the first interface part to form the dosing head with the second interface part, which is assigned to the second dosing head component. Preferably, the engagement of the interface element can be controlled by a control device assigned to the dosing system, preferably a higher-level control device assigned to the dosing system.

In an optional step, an actuator of an actuator unit can be adjusted. An adjustment is particularly advantageous for a jet valve with a movable ejection element with regard to dosing accuracy. Preferably, the adjustment can be carried out in such a way that in a defined operating state of the actuator, in particular in a deflected operating state of the actuator, a certain contact force of an ejection element into a nozzle of a fluidic unit is generated by the actuator. The adjustment process can be controlled via a higher-level control device assigned to the dosing system. Preferably, the adjustment process can be controlled via a dosing system's own (local) control unit. It is also possible for an adjustment process to be initiated by a higher-level control device, whereby the actual adjustment is then controlled by a dosing system's own (local) control unit.

Preferably, in a method for controlling at least one dosing system with at least one dosing head, preferably a dosing system according to the invention and/or a dosing system for a dosing installation according to the invention, for controlling a dosing material dispensing from the dosing head, a first dosing head component can be detachably coupled at least once via a first interface part, which is assigned to the first dosing head component, with a second interface part, which is assigned to a second dosing head component in an automated process for forming a dosing head. Preferably, the automated coupling is carried out according to the previously described method for automated coupling.

Preferably, in the control method it can also be provided that a first dosing head component of a dosing head is changed at least once in an automated process, i.e. for example, is replaced by a functionally equivalent component, in particular according to the previously described method for automated coupling. This means that an automated change process can be integrated into the control process.

Advantageously, the automated change method or the automated change process are also based on the same inventive concept as described with reference to the dosing installation. Accordingly, the same advantageous effects as described initially are obtained for this method.

Further, particularly advantageous embodiments and further developments of the invention are obtained from the dependent claims and the following description, wherein the independent claims of one claim category can also be further developed analogously to the dependent claims and exemplary embodiments of another claim category and in particular also individual features of different exemplary embodiments or variants can be combined to form to new exemplary embodiments or variants.

A dosing installation as described initially comprises at least one, preferably a number of, i.e. two or more, separate dosing devices. A dosing installation can, for example, be an entire production facility and can comprise at least the components required to carry out the invention. This means that a dosing installation preferably comprises respectively at least one dosing device, one change system, one dosing system, one dosing head and one control device.

If a dosing installation has two or more dosing devices, different manufacturing products can be manufactured on the individual dosing devices. Accordingly, the respective dosing devices can be operated separately from one another. In particular, the respective dosing devices can be controlled separately by a control device.

Preferably, a dosing installation can have a control device that can control all the components of the dosing system separately. This control device can contain all the hardware components, such as interfaces to the individual components of a dosing installation and can be programmed accordingly to supply the respective components with control signals for an automated coupling and/or decoupling process and/or to control a dosing process of the individual dosing valves. Such a control device is designated as a “higher-level” control device and can be implemented centrally. Preferably, however, a higher-level control device is configured in a decentralized manner.

For example, a preferably decentralized control device can comprise a system of a plurality of cooperating sub-control units, which can also be arranged at different positions in a dosing installation. It would also be possible that a respective dosing system is assigned its own sub-control unit which, for example, can also be arranged in the dosing system itself. Preferably, the respective sub-control units can communicate with each other, in particular to exchange control signals and/or measurement signals.

Preferably, a higher-level control device can comprise at least two interacting sub-control units. Preferably, a (first) sub-control unit can then be designed to carry out a control of certain installation functions of a dosing installation, in particular installation functions that do not relate to the dosing process itself. Preferably, such an “installation control unit” can control at least a positioning of a dosing valve in the dosing installation and/or a handling of manufactured products, in particular a transport of manufactured products to or from a dosing point, and/or perform a monitoring function, in particular with regard to a dosing precision of a respective dosing valve, e.g. via a camera. This installation control unit can, for example, be implemented by means of a standard programmable logic controller (PLC). Preferably, a specific configuration of a dosing installation, in particular a position of components in the dosing installation, can be stored in the installation control unit.

Preferably, the installation control installation can interact with a (second) sub-control unit which controls the actual dosing process of the respective dosing valves in a dosing installation and/or an automated coupling and/or decoupling process at a specific dosing valve (hereinafter “operational control unit”). Preferably, the installation control unit and the operational control unit can communicate with each other, in particular to exchange control signals. The operational control unit can preferably control at least the following elements of a dosing installation separately: a change system, in particular a magazine for dosing head components, as well as the respective dosing heads of a dosing installation, in particular the interfaces of the respective dosing heads.

It is fundamentally possible for an entire coupling and/or decoupling process to be controlled solely by the operational control unit.

However, it is preferred that two or more sub-control units cooperate for automated coupling or decoupling of a dosing head component. Preferably, the installation control unit can control the involved components of a dosing installation in such a way that a specific (to be partially exchanged) dosing head is moved to a change position. To carry out the actual change process, the operational control unit can, preferably depending on control signals from the installation control unit, control the components involved in the change process, i.e. in particular a change system and the interface parts of a specific dosing head. After completion of the change process, in particular depending on control signals from the operational control unit, the dosing head can be returned to a working position via a control by the installation control unit.

Preferably, the operational control unit can also generate control signals and/or pass them on to the installation control unit in order to arrange a specific (to be partially replaced) dosing head in a change position, in particular depending on status values recorded by the operational control unit. This will be described subsequently.

For the sake of completeness, it should be noted that, in principle, a single, possibly central, higher-level control device could also carry out the process steps for the automated coupling or decoupling and could also control the dosing process of the dosing valves, i.e. to control a dosing installation according to the invention as a whole. For example, an installation control unit could also be designed to carry out the described change procedure.

In the description, without any limitation, a higher-level control device with at least two interacting sub-control units is taken as the starting point since particular advantages can be obtained in this case. For example, when implementing the invention in an existing dosing installation, an already existing control device could be used, so that for example, only the special operational control unit for controlling the automated change process needs to be retrofitted.

A higher-level control device can preferably also have a regulating function. For example, operating parameters of the respective dosing systems or their subcomponents can be fed into the control device and processed there. Preferably, the higher-level control device can intervene in a regulating manner in the dosing operation of a specific dosing system or dosing head and/or a specific dosing device taking into account at least one operating parameter so that a target value of the operating parameter is reached. Such a parameter could be, for example, an actuator deflection or a plunger stroke during operation.

Preferably, the higher-level control device can be designed to continuously actively monitor at least one status value, preferably of at least one component, of a dosing system, in particular of a dosing head, during operation of the dosing installation. Such a status value can, for example, be a wear parameter, a temperature or a degree of wear of an individual component of a dosing system, e.g. a degree of wear of an ejection element.

Further status values can be a defined (pre-determinable) number of shot cycles, (sensor) signals of a drop detection, in particular a lack of drop break-off, signals from flow sensors in the feed channel, in particular a flow rate deviating from a target value, signals from fill level sensors of a dosing material cartridge, expiration of a defined time interval, in particular with regard to a processing time of a dosing material or reaching a regular maintenance interval of a component. Preferably, a change process can be triggered by the operational control unit depending on these status values.

A status value can also be a dosing performance or dosing precision of a specific dosing valve that deviates from a target value. Preferably, a status value can then be a quantity of dosing material that is dispensed from a dosing head during a respective ejection process and/or a shape of a dispensed dosing material drop. Preferably, corresponding measured values can be fed to the higher-level control device, for example, to the installation control unit, whereby depending on these measured values or status values a change process can be triggered. The corresponding measured values can, for example, be produced using a scale or a camera system as part of the dosing installation. Preferably, the control device, in particular the higher-level control device, can compare the respective status value during operation, in particular in real time, with an associated predetermined target value, whereby a remaining service life of a component can be determined and/or a time for a change (change time) of a dosing head component can be (pre-) determined.

For example, the control device can carry out an automated change of a component as soon as a certain status value, e.g. a wear parameter reaches and/or exceeds a maximum permissible value and/or deviates by a certain value from an assigned target value. Optionally, a change message or a wear message could be generated beforehand by the control device, which must be optionally confirmed by a user. Preferably, the control device can decide which type of dosing head component is to be changed based on a status value of a dosing system, in particular based on a status value of a specific component of a dosing system or a dosing head.

Preferably, for example, a higher-level control device may be designed, for example an installation control unit, in particular if the dosing installation comprises a number of dosing systems and/or dosing devices, to create a sequence plan for the automated change process. Preferably, the control device, taking into account status values of different dosing systems or dosing heads, can plan the component change in the dosing installation in such a way that the operation of the installation can be carried out as uninterruptedly as possible. Preferably, the remaining service life of a component, the type of dosing head component to be replaced, an exact time of exchange, a location of an exchange, i.e. the spatial position of the dosing system or the dosing head and/or the dosing device in the installation, can be taken into account in the sequence plan.

Alternatively or additionally, the control device can also be programmed so that a specific component and/or a specific dosing head component is routinely changed, e.g. at a certain interval. Accordingly, the control device could carry out an automated change when the predefinable value (status value) is reached or take the planned change into account in the sequence plan. Such a parameter can be, for example, a maximum service life of an ejection element or a maximum permissible number of expansion cycles of a piezo actuator or a certain number of shot cycles. In principle, it is also possible to intervene manually in the automated change process, e.g. if (exceptionally) a certain dosing head component is to be changed regardless of whether a status value is reached or for other reasons, i.e. the change process can also be carried out by manual (user) input.

For the sake of completeness, it should be noted that in a dosing installation designed for an automated change process, it is also possible for a dosing head component to be coupled and/or uncoupled (purely) manually by a user.

The higher-level control device, e.g. an installation control unit and an operational control unit cooperating therewith, is preferably designed to independently carry out all the method steps of the method for automated coupling and/or decoupling (change method), preferably also of the control method, and/or to supply the modules involved with corresponding control signals for carrying out the respective method, in particular taking into account the previously generated sequence plan.

In principle, as mentioned, it is also possible for the individual dosing systems and/or the individual dosing devices to each have their own, separate (local) control unit, in particular in the form of sub-control units. Preferably, the sub-control units of the dosing systems are at least designed to locally control the dosing operation of a respective dosing system, e.g. by controlling cooling and/or heating devices of the dosing system to set a specific temperature in a dosing material or by setting a clock frequency of the dosing material dispensing.

Preferably, the respective sub-control units of the dosing systems can communicate with other sub-control units of a dosing system, in particular also with an operational control unit and/or an installation control unit. In particular, the sub-control units of the dosing systems can also be designed to form an operational control unit. This means that the sub-control units of the dosing systems themselves can form an operational control unit as part of a higher-level control device.

A local control unit of a dosing system, in particular a sub-control unit, can for example be arranged in an actuator housing of a respective dosing system. In this case, a dosing head which has a portable dosing material supply could itself form a complete dosing system. In principle, especially if a dosing installation comprises only a single dosing system, it would be possible for a control device of the dosing installation to be implemented as part of a specific dosing system. For example, the (local) control unit of a dosing system could in principle also be designed to control both the dosing operation of the dosing system and the procedure for an automated change.

However, it is preferred that a respective dosing head can also be controlled by a (complete) higher-level control device, in particular by an operational and/or installation control unit, in addition to its own, preferably integrated, sub-control unit. Preferably, a higher-level control device can then, as mentioned, control at least the functions of a dosing head that are integrated into a coupling and/or decoupling process of a dosing head component.

This means that a dosing system is preferably designed such that a respective dosing valve or dosing head during operation, is assigned preferably the same in each case, e.g. external higher-level control device, whereby the higher-level control device can control the individual dosing valves or dosing systems separately. As mentioned, this does not exclude the fact that a dosing head additionally has an (internal) sub-control unit, in particular for controlling the dosing operation.

Hereinafter, it is assumed—without any limitation—that the dosing installation comprises a previously described higher-level control device, which is also designed to control and/or regulate the dosing operation of the respective dosing valves or dosing systems separately. In this configuration described hereinafter, a respective dosing head forms a dosing valve and is designed as a sub-unit of a respective dosing system, wherein the dosing operation can be controlled, at least partially, by a (possibly external) higher-level control device. Accordingly, a respective dosing head in combination with the associated higher-level control device and preferably a (local) partial control unit as well as an associated dosing material storage device can form a complete dosing system. The higher-level control device can preferably be implemented at least partially as part of a dosing device or can be designed independently thereof and/or in a decentralized manner at several locations, in particular if a dosing installation has a plurality of dosing devices.

As described initially, a dosing installation can comprise two or more dosing devices. For the sake of clarity, the invention is described hereinafter—unless otherwise stated and without limitation—by means of a single dosing device, wherein the dosing device comprises a supply device and a higher-level control device. For example, the dosing device has only one dosing system or one dosing head. However, it should be noted that a dosing device according to the invention can usually comprise a plurality of dosing systems or dosing heads that can also be operated independently of each other. It is possible that a dosing device has different dosing systems, which e.g. can have a different configuration. Accordingly, the advantageous further developments of the invention, even if they are described with reference to a single dosing head, are equally applicable to a plurality or a multiplicity of dosing heads or dosing systems.

A particular advantage of the invention is that a specific dosing head component can be specifically changed during operation of a dosing installation. Depending on the design of a dosing system and/or depending on a dosing head component to be replaced, the first or second dosing head component can be formed by different components or elements of a dosing system. Preferably, a specific (matching) second dosing head component can be assigned to a first dosing head component, in particular depending on a design of a component to be exchanged, wherein different components of a dosing system (as first or second dosing head component) can be combined with one another, i.e. coupled.

Preferably, a first dosing head component can comprise at least one of the following elements, in particular can be selected from the following components: a fluidic unit, a fluidic base body, a nozzle, a nozzle base body, a nozzle element or a dosing material supply.

Preferably, a second dosing head component can comprise at least one of the following elements, in particular be selected from the following components: an actuator unit, a fluidic unit, a fluidic base body or a nozzle base body.

For example, a first dosing head component can comprise or be formed by a (complete) fluidic unit. Then, preferably, a second dosing head component can comprise an actuator unit or be formed thereby.

In another combination, the first dosing head component can be a fluidic base body, whilst the second dosing head component can be an actuator unit. A fluidic base body is a part of a (complete) fluidic unit, which part then preferably comprises at least one frame, one feed channel and one functional coupling element for forming a functional coupling and possibly other elements. Preferably, a fluidic base body and an associated (complete) nozzle, which can preferably be coupled to the fluidic base body, can form a fluidic unit.

The previously described combination of a fluidic base body as the first dosing head component with an actuator unit as the second dosing head component can preferably be an intermediate step in an exchange process. Accordingly, in a subsequent process step, the (same) fluidic base body can then form a second dosing head component, in which case a nozzle, for example, can then be coupled as the first dosing head component. It is therefore possible, at least as an intermediate step in a change process, that the same dosing head component is a first dosing head component in one combination and a second dosing head component in another combination.

It would also be possible that a fluidic base body forms a second dosing head component from the beginning in a change process, in which case a (complete) nozzle or a nozzle base body or a specific nozzle element can be coupled as the first dosing head component. A nozzle base body is a part of a (complete) nozzle and could be coupled as the first dosing head component, e.g. in an intermediate step of a change process, to a fluidic base body, wherein in a further step a nozzle element (as a first dosing head component) can be coupled thereto to form a nozzle or a dosing head, wherein the same nozzle base body is then a second dosing head component.

Furthermore, a nozzle base body can also form a second dosing head component from the beginning in a change process, in which case a specific nozzle element can then form a first dosing head component that can be coupled thereto.

In another combination, a portable dosing material supply can be coupled as the first dosing head component to a fluidic unit as the second dosing head component. The preferred coupling variants are described in more detail hereinafter.

A preferred dosing installation comprises a change system with at least one magazine or an (intermediate) store for storing at least one first dosing head component. Preferably, the magazine can be designed so that two or more separate dosing head components can be stored therein at the same time. The terms “dosing head component” and “component” are used synonymously to describe the invention.

In its simplest form, a magazine or interchangeable magazine can be a static one, e.g. linear magazine with at least one storage location, preferably two or more separate storage locations, each for one dosing head component. Such a static magazine has the advantage that it is comparatively inexpensive and is suitable if only a few dosing head components are to be stored at the same time.

Preferably, however, a magazine can be designed such that at least one dosing head component is movably mounted in the magazine. For example, a magazine can be realized by means of a carousel (carousel magazine), in which case, for example, a horizontally rotating wheel has a number of storage locations. Furthermore, a magazine can be designed in the form of a “free track” with at least one movable chain, wherein the movable chain has a plurality of storage locations for respectively one dosing head component. Movable storage in the magazine could, for example, also be achieved by means of a controllable conveyor belt in the magazine.

Advantageously, a comparatively large number of dosing head components can be temporarily stored simultaneously in a magazine for movable storage, which is particularly advantageous for large dosing installations so that an unnecessarily large number of magazines need not be kept in readiness.

Regardless of the specific design, a magazine of the change system is preferably designed to store different designs of dosing head components, in particular simultaneously, particularly preferably the previously described elements as possible first dosing head components. Accordingly, at least two storage locations or the receiving points in a magazine can be designed differently so that different embodiments of dosing head components can be stored therein.

To store a dosing head component in the magazine, the magazine can comprise a, preferably controllable, locking mechanism. The locking mechanism is preferably designed to hold in the magazine the components stored in the magazine during a movement of the magazine as intended, e.g. when the magazine is moved in the dosing installation. Preferably, each storage location in the magazine can be assigned a partial locking mechanism to be operated separately. For example, a respective dosing head component can be locked in the magazine by means of a separate snap mechanism. Alternatively or additionally, the locking can also be accomplished by means of a positive connection. For example, a specific dosing head component could be attached to a complementarily formed counterpart at a storage location. In principle, it would also be possible to suspend a dosing head component in a storage location, in which case the dosing head component is then held by its own weight.

Regardless of the specific design, a magazine can be arranged in a fixed location in the dosing installation. For example, a stationary magazine can be arranged in a maintenance area of the dosing installation, in particular spatially separated from a dosing system or dosing head and/or a dosing device. Then it is preferred that the dosing device is at least partially movable in order to bring a second dosing head component on the dosing device into a specific change position, e.g. at the location of a magazine, in particular via control by an installation control unit.

Preferably, the dosing device can be at least partially movable, in particular with respect to the magazine, and can be designed and controlled such that a second dosing head component on the dosing device is brought into operative contact with a first dosing head component in the magazine in an automated process for coupling the dosing head components. In particular, the first and the second dosing head components can be coupled as a result of the operative contact.

If a dosing device comprises a number of dosing systems, it is preferably designed to be controllable in such a way that, in the automated process, a specific second dosing head component on the dosing device can be brought into operative contact with a specific first dosing head component in the magazine. This means that at least one element of the dosing device, preferably the entire dosing device, can be controlled such that a specific second dosing head component is moved towards the magazine for coupling the two dosing head components. The dosing device can comprise for this purpose, for example, a mobile robot system or another positioning system, e.g. a three-axis positioning system. Preferably, at least one movable part of the dosing device can be designed to be able to approach or control a specific position in a magazine. The movable part of the dosing device or the movable dosing device as a whole can be referred to as a “working manipulator”.

Preferably, the dosing device can have at least one, preferably several separately controllable robot arms as a working manipulator, e.g. multi-axis articulated arm robots, where each robot arm can be assigned a dosing system. Preferably, a part of a respective robot arm can be arranged in a fixed position in the dosing system and/or can be in operative contact with the supply device or the control device. A second part of the same robot arm can be movable in the dosing installation, in particular with respect to a magazine and/or a change position and/or a dosing point. The dosing system, in particular a second dosing head component, can be detachably arranged on the movable part of the working manipulator. In this embodiment, the respective first dosing head component can be provided via the coupling region in the magazine, which is part of the change system, such that the working manipulator with the second component can access the first component in the magazine to form the dosing head.

Preferably an at least partially movable dosing device, e.g. a respective work manipulator can be controlled, in particular by a higher-level control device, in such a way that a first dosing head component of a (mounted) dosing head is deposited in the magazine in an automated process (decoupling process), preferably at a specific position.

A stationary magazine can also be arranged in a fixed position on, i.e. in a fixed position in relation to, an actuator unit and/or in a fixed position on a fluidic unit and/or in a fixed position on a nozzle of a dosing system. Details will be given subsequently.

Alternatively or additionally, a magazine can be designed to be movable with respect to the dosing device and can be controlled by a, preferably higher-level, control device in such a way that a first dosing head component in the magazine is brought into operative contact with a second dosing head component on the dosing device in an automated process for coupling the dosing head components, which in particular leads to the coupling. Furthermore, the magazine can be designed to be movable and can be controlled in such a way that a first dosing head component of a (mounted) dosing head is deposited in the magazine in an automated process, preferably at a specific position.

In this case, the magazine is spatially moved towards or away from the dosing device and/or the dosing system. A movable magazine could, for example, include a controllable robot system. A movable magazine can be used particularly advantageously in combination with a static (in a fixed position in the dosing installation) dosing system or a “static manipulator”. This is the case, for example, with dosing systems for dosing devices that dose onto a conveyor belt. In principle, a combination of the previously described embodiments would also be possible. For example, a dosing head component could be brought by means of an at least partially movable dosing device, e.g. a working manipulator, into a specific change position, whereby a movable magazine (as part of the change system) is brought into this same change position for coupling or decoupling.

Particularly preferably, the change system can comprise a movable change device, which is referred to as a “change manipulator”. Preferably, the change manipulator is designed and can be controlled by a, preferably higher-level, control device in such a way that a transfer of at least a first dosing head component between a magazine and a dosing device and/or a dosing system or dosing head can be carried out in an automated process.

In particular, the change device can be designed to be controllable in such a way that, in an automated process, a first dosing head component from a magazine is brought into operative contact with a second dosing head component on a dosing device for coupling via the change device and/or in such a way that a first decoupled dosing head component is transferred from a dosing device to a magazine. In this case, a change position of a dosing head component can be directly on site, i.e. directly at a dosing device. In particular, a change position can be an operating position of the dosing device and/or a specific dosing head.

The change manipulator preferably constitutes a separate intermediate system and can transport at least one dosing head component from a magazine to a dosing device and vice versa. For this purpose, the change manipulator is accordingly supplied with appropriate signals from the, preferably higher-level, control device. The change manipulator can have two or more receiving positions for one dosing head component each, optionally each with an associated controllable locking mechanism.

Particularly preferably, the change manipulator can have at least one controllable “access element” which is designed to functionally cooperate with a coupling region of a first dosing head component for coupling and/or decoupling the component. In particular, the access element can be designed such that it interacts with a coupling region of a dosing head component in such a way that, as a result of the interaction, a coupling and/or decoupling of two components can be carried out.

Preferably, the access element can be realized by means of a controllable gripping element. For example, the access element could comprise a controllable pneumatic and/or electric gripper or be implemented by means of such a gripper. It would also be possible for an access element to have a recess complementary to the respective coupling region of a dosing head component, so that when the recess and the coupling region are brought together, a positive connection is created, whereby coupling and/or decoupling takes place thereby.

Preferably, a separate access element can be assigned to each respective receiving position in the change manipulator. It is preferred that a respective access element itself forms a receiving area for a dosing head component.

The change manipulator can preferably comprise a controllable robot arm. It would also be possible to use a change manipulator in the form of a base frame movable, e.g. displaceable in the dosing installation, wherein the base frame could have at least one controllable robot arm. In particular, the base frame can be designed to be freely movable in a dosing installation, wherein a direction of movement can preferably be determined by a (higher-level) control device.

Alternatively or additionally, a change manipulator can also be realized by means of a transport device, which can preferably be fixedly installed in a dosing installation. For example, the transport device can have a guide system, wherein at least one access element and/or a receiving position for a dosing head component is designed to be movable along at least one guide plane of the guide system, in particular with a linear movement. Preferably, the guide system also has two or more guide levels or guide axes, whereby the guide system can be designed in particular as a two-axis or three-axis robot (XYZ system). In principle, a dosing installation can also have different change manipulators as part of a change system.

Advantageously, a spatial distance between a magazine and a dosing device can be overcome by means of a (movable) change manipulator. On the one hand, this has the advantage that the magazine and/or the dosing device can be designed to be in a fixed position in relation to each other or in a fixed position within a dosing installation (static), which makes the assemblies more cost-effective. Further advantageously after replacing a dosing head component, the change manipulator can be completely removed from the working area of a dosing device so that the working area is not permanently restricted. Further advantageously in a stationary dosing device with several dosing systems, a component change can also take place during operation of the dosing device, i.e. whilst the other dosing systems are active. In contrast to a manual component change, with a controllable change manipulator it is not necessary to switch off the dosing device for safety reasons.

It should be noted that a movable change device can in principle also be used in combination with a movable magazine and/or with an at least partially movable dosing device, in particular with a working manipulator. For example, a dosing head to be (partially) replaced can be transferred to a specific change position by means of a working manipulator, whereby the movable change device is controlled in such a way that it is arranged in the same change position in order to perform a change of a component.

Preferably, a change system can be designed and capable of being controlled by a control device such that a specific first dosing head component from a magazine can be brought into operative contact with a specific second dosing head component on the dosing device, e.g. on the working manipulator, to couple the dosing head components. A “certain” first dosing head component can, for example, be a component that is intended to replace a structurally identical component to be exchanged. A specific component could also be characterized by the fact that a specific dosing pattern can be achieved by means of the component. For example, a particular dosing head component can have a special nozzle shape and/or a special ejection element in order to achieve a required configuration of a dosing system during operation, in particular taking into account the nature of the actuator unit.

In order to selectively couple a first dosing head component from the magazine with a second dosing head component, for example, a movable magazine (as part of the change system) can be spatially positioned in a corresponding manner in relation to the second dosing head component on a dosing device.

Preferably, the magazine can comprise an internal (magazine) movement mechanism to bring a specific dosing head component and/or a specific (free) storage location into a defined position, in particular to a “transfer point”. A transfer point or a transfer position of a magazine part can preferably be characterized by a spatial arrangement in relation to a dosing device, wherein in the transfer position, for example, a coupling and/or a decoupling of a first component can take place. For example, a working manipulator for an automated change could be controlled in such a way that a dosing head component to be decoupled is moved into the same transfer position. Preferably, for coupling and/or decoupling, in particular during coupling and/or decoupling, a transfer position of the magazine can substantially coincide with a change position of a dosing head component.

Alternatively or additionally, a change manipulator (as part of the change system) can be designed to be controllable in order to selectively pick out a specific dosing head component from a magazine. Preferably, the change manipulator can have a detection means for contactless detection and/or assignment of a specific dosing head component. Preferably, identification can be carried out via an RFID system (radio frequency identification). Alternatively or additionally, the respective dosing head components can identified, for example, via a machine-readable code such as a barcode that can be read by the change manipulator. It would also be possible that the change manipulator has a position determination system and can move to a predeterminable position in the dosing installation, in particular a specific position in a magazine, preferably by means of a control by the, preferably higher-level, control device.

Advantageously, by means of such a controllable change system it can be achieved that a magazine can simultaneously store a large number of different dosing head components for example, so that fewer magazines are required in an installation, in which case it is nevertheless ensured that two defined dosing head components are coupled. A magazine with an internal movement mechanism has the additional advantage that, for example, a (locally) movable magazine can be brought close to a first component of a dosing head to be decoupled in such a way that a free storage location in the magazine is already arranged in a transfer position. After the component has been uncoupled and received in the magazine, a specific “new” dosing head component, i.e. to be coupled, can be provided in the transfer position for coupling via the internal movement mechanism, e.g. by moving the carousel wheel by one position. Advantageously, the magazine and/or the dosing head and/or the dosing device barely need to be moved with respect to each other for the actual change. Due to the particularly short changeover paths, an additional saving of time is possible during the change. The same advantage can be achieved with a dosing device with working manipulators.

Further advantages arise from a combination of a movable change manipulator with a magazine having an internal movement mechanism. The magazine can be controlled, for example, in such a way that a free storage location is arranged in a transfer position and can then cooperate with the change manipulator in such a way that an “old”, i.e. decoupled, component is picked up. After the old component has been transferred, a “new” component, i.e. a component to be coupled, can be provided in the same transfer position via the internal movement mechanism and picked up by the change manipulator without the change manipulator itself having to be moved. By this means the transfer time of components between the magazine and the change manipulator or the dosing device can be reduced.

In principle, it would also be possible to combine the previously described embodiments.

This means that a dosing installation has at least one stationary magazine and/or at least one movable magazine, each with or without an internal movement mechanism, and/or at least one dosing device that is at least partially movable, e.g. one or more working manipulators and/or at least one static dosing device and/or at least one movable change manipulator, which can interact with each other for coupling or decoupling. Depending on the embodiment, a dosing device can preferably have a respective working manipulator, a previously described detection means for contactless detection and/or assignment of a specific (first) dosing head component.

A magazine of the change system can, regardless of the specific design, have at least one maintenance coupling element which is designed to cooperate with a coupling element, in particular a supply coupling element described hereinafter, of a first dosing head component to form a maintenance coupling. Preferably, a mechanical interface and/or an electrical interface and/or a fluid interface can be formed via the maintenance coupling element. Preferably, each storage location for a component in the magazine can be assigned a separately controllable maintenance coupling element to form a respective maintenance coupling.

The maintenance coupling is preferably designed to connect at least one supply line of a first dosing head component to an external maintenance device, in particular during storage of the component in the magazine. A supply line can, for example, be a supply line for controlling a heating device of the fluidic unit and/or a supply line for a dosing material and/or a supply line for a dosing material pressure.

Preferably, the maintenance coupling is designed to introduce a cleaner for cleaning a dosing head component into the component via the maintenance coupling, in particular during storage in the magazine. Alternatively or additionally, the maintenance coupling can be designed in such a way that a heating device of the dosing head component can be controlled and/or a memory assigned to the dosing head component can be read out. To form the maintenance coupling, a fluidic unit (as the first dosing head component) can have a supply coupling element, as described subsequently.

Advantageously, the operation of a respective maintenance coupling can be controlled by means of a, preferably higher-level, control device, wherein the control device, for example, can read data from an EEPROM assigned to the heating device of the fluidic unit. Further advantageously a (pre-) cleaning of a dosing head component, in particular a fluidic unit, can be carried out via the maintenance coupling during storage in the magazine, so that hardening of material in the fluidic unit is prevented and possible later maintenance or possible further cleaning is facilitated.

Further advantageously, due to control of the heating device in the magazine for example, a nozzle and/or the entire fluidic unit and/or a dosing material in the fluidic unit can be preheated to a specific (operating) temperature, in particular before an impending change of a corresponding dosing head component. Advantageously, a dosing process can be continued directly after a dosing head component has been changed, whereby a maintenance or heating time can be avoided.

In order to form the maintenance coupling, a respective maintenance coupling element in the magazine is preferably designed to be complementary to a specific partial region of a first interface part of a first dosing head component. Accordingly, it is preferred that the first interface part, which is assigned to the first dosing head component, is designed in multiple parts. Particularly preferably, a partial region of the first interface part forms a supply coupling element complementary to the maintenance coupling element.

Alternatively or additionally, the second interface part, which is assigned to the second dosing head component, can be designed in multiple parts. This means that such an interface part for forming an interface, in particular for coupling the first and second components to form a dosing head, can consist of several separate, preferably spatially separated, elements.

Preferably, in one embodiment of the invention, the first interface part can be assigned to a fluidic unit, wherein the fluidic unit is then the first dosing head component. The first interface part can be designed as part of the fluidic unit itself. Alternatively or additionally, the first interface part can be arranged, at least in sections, on the fluidic unit. In the description, it is assumed, without limitation, that the first interface part is arranged on the first dosing head component.

Accordingly, in this case, a unit to be replaced consists of the entire fluidic unit and the first interface part. In the context of the invention, the media-carrying part of a dosing system is designated as fluidic unit or fluidics. The fluidic unit comprises as main components at least one nozzle for dispensing dosing material and at least one fluidic base body with a feed channel for the dosing material to the nozzle. Depending on the design, the fluidics can have a connection for an external dosing material supply and/or a coupling point for a portable dosing material supply, e.g. for a cartridge. The fluidic unit can preferably have a controllable heating device and/or a cooling device for dosing material. In a jet valve, the fluidic unit can have, inter alia, a movable ejection element, a guide for the ejection element and a seal between the media-carrying part and the drive of the jet valve. Preferably, the described parts—with the exception of the nozzle—form a fluidic base body which can be coupled to a nozzle to form a fluidic system.

The first interface part on the fluidic unit is preferably designed in multiple parts, wherein a first interface element has a supply coupling element for forming a supply coupling. The supply coupling element is preferably designed to couple at least one supply line of the fluidic system to or onto an (external) supply device during operation of the dosing head or the dosing system. Preferably, the supply coupling element can be designed to functionally couple two or more separate supply lines, each with an associated line in the second interface part. The supply coupling is preferably designed to establish at least one, preferably several, electrical and/or mechanical and/or signalling and/or pneumatic and/or fluid-technical, in particular media-conducting, connections between the first and the second interface part during operation of a dosing head. The supply coupling element can be arranged directly or only indirectly on the fluidic system.

A supply line can, for example, be a line for media pressure supply, e.g. to apply pressure to a dosing material in a portable cartridge or dosing material cartridge carried by the fluidic system as dosing material supply. A supply line can also be designed to supply a dosing material directly to the fluidic system (if no cartridge is provided). Furthermore, a supply line can also be designed to control a heating device and/or a cooling device in the fluidic unit. Preferably, the temperature, the pressurization of the cartridge or the media feed into the fluidics unit can be controlled via the control device and, if necessary, forwarded to the fluidics via the supply coupling.

In order to form a supply coupling, the second interface part is preferably designed in multiple parts, wherein at least a first interface element of the second interface part is designed to be complementary to the supply coupling element of the first interface part of the fluidic unit.

Preferably, the first interface element of the second interface part can be designed separately with respect to the second dosing head component, in particular spatially separated from the second dosing head component. Preferably, the first interface element of the second interface part can be assigned to a dosing device, in particular arranged thereon, and/or be in operative contact with a supply device and/or a control device. If a dosing head is arranged on a working manipulator, the working manipulator can provide a second interface part with a first interface element that is formed separately with respect to the second dosing head component. The supply device can preferably be designed as part of a dosing device and is preferably controllable in such a way that, during operation, several dosing systems can be controlled separately via the respective supply lines.

The supply coupling is preferably designed as a coupling system for an automatic change function. For example, the supply coupling can be implemented as a multi-coupling or multiple coupling can be realized, preferably in the form of a quick-change coupling. Such coupling systems are known, for example, from tool change systems or robotic tool changers and can be based on an electrical and/or pneumatic and/or hydraulic connection of the coupling parts to form the coupling. In principle, a mechanical connection of the coupling parts is also possible.

The supply coupling is preferably designed such that the making and/or breaking of the supply coupling is accomplished by means of control by a control device. For example, before mechanically or physically disconnecting the supply coupling, the media-carrying lines can be depressurized and/or the electrical lines can be de-energized.

The supply coupling element in the first interface part can have at least one closing mechanism which is designed to close at least one supply line leading to the fluidic unit in a gas-tight and/or liquid-tight manner in the decoupled state. In particular, a respective fluid-carrying line can be designed to be self-sealing in such a way that media leakage from the line is prevented when the interface is open. In the same way, the interface element of the second interface part could also have at least one locking mechanism. For example, a supply coupling element on the first and/or second interface part can be designed as a “self-closing coupling” (closing coupling).

In order to form a functional dosing head, the first interface part on the fluidic unit can have a first, preferably separate, functional coupling element in addition to the supply coupling element. Accordingly, a second interface part can have a complementary second functional coupling element for forming a functional coupling. Preferably, the functional coupling and the supply coupling can be spatially separated from each other.

Preferably, the second functional coupling element is assigned to an actuator unit (as a second dosing head component). In particular, the second functional coupling element can be arranged on an actuator unit. The actuator unit can preferably be arranged for coupling to a dosing device, e.g. on a working manipulator.

Preferably, the first interface part and/or the second interface part, in particular both interface parts, are designed to detachably couple the fluidic unit to the actuator unit via an interaction between the first and the second functional coupling element, in particular in an automated process. The coupling region for the change system can be provided by a fluidic framework.

The functional coupling is preferably designed to establish a mechanical, reversible connection, in particular essentially free of play, between a fluidic unit and an associated actuator unit. Preferably, a connection is established between the fluidic unit and the actuator unit via the functional coupling in such a way that a (mounted) dosing head can withstand acceleration forces of up to 10 g during operation of a dosing system.

The supply coupling and/or the functional coupling are designed in particular to be controllable by a preferably higher-level control device in such a way that a first and a second dosing head component are coupled via the respective coupling systems to form a functional dosing head.

Advantageously, all media-carrying components of a dosing valve can be replaced together in one operation in an automated process via an interface consisting of several separate sub-interfaces. Cases of application include, for example, a pending cleaning of parts of the fluidic unit for a consistent dosing result. In a dosing system with a dosing medium supply carried on the fluidic unit, the fluidic unit can be replaced to refill the dosing medium. In both cases, the entire fluidic unit can be released from a dosing head quickly and without manual intervention and can be serviced outside the working area of the dosing system, so that there is no delay in operation. When changing the configuration of a dosing system (e.g. with regard to nozzle, ejection element, medium), the set-up time of the dosing system or dosing device can be shortened.

Advantageously, via such an interface dosing systems with an entrained (self-sufficient) dosing material supply as well as dosing systems that are continuously supplied with dosing medium via a supply device can be coupled. For example, the supply coupling element in the first interface part and the complementary counterpart, e.g. on the dosing device, can be specially adapted to the design of the fluidic unit or its operating mode, in terms of the coupling technology. However, it is preferred that the respective supply coupling elements are designed to provide both a media pressure supply (via which the medium held in a cartridge on the fluidic unit is pressurized) and a (continuous) media supply in a single supply coupling, wherein the media pressure supply and the media supply can then preferably be controlled separately, e.g. taking into account the operating mode of the respective fluidic unit that is currently coupled. Advantageously, the second interface part, for example, on a dosing device would then be compatible with differently operating dosing valves.

Further advantageously via such an interface, especially those components of a dosing system that must be maintained or replaced particularly frequently can be exchanged. These include in particular ejection elements and their seals as well as nozzle inserts for nozzles. Such wear items can be removed particularly quickly from a dosing head by exchanging the fluidic unit and replaced with functionally equivalent components, wherein dosing operation is interrupted for the shortest possible time. As mentioned, a change of the fluidic unit can be necessary due to a standard maintenance interval or in the event of a damage report, i.e. when the dosing process is actively monitored by a control device.

The previously described advantageous effects are obtained regardless of the exact operating mode of a dosing system due to the possibility of a reversible coupling of a fluidic unit with an actuator unit. In the context of the invention, an actuator unit is generally understood to mean the drive of a dosing system. A piezo drive, a pneumatic drive, an electromagnetic drive or a combination thereof, for example, can be provided as form of drive. An actuator unit typically has a housing that houses the drive and other components. The actuator unit can have a number of sensors, e.g. temperature sensors and at least one controllable heating and/or cooling device. Furthermore, an actuator unit can also comprise a local control unit as already mentioned, in particular a sub-control unit.

In the description of the invention, it is assumed, without any limitation, that the dosing system for dispensing the dosing material has a jet valve, since this functional principle offers particular advantages. Then the actuator unit preferably has at least one controllable piezo actuator and/or a pneumatic actuator as well as an ejection element cooperating therewith for dispensing the dosing material. For a particularly high dosing precision during operation, the piezo actuator or the pneumatic actuator is preferably designed to be adjustable. Details will be given subsequently.

For coupling the first and the second dosing head component, the functional coupling element can have a first plug-in coupling part on the first interface part. Accordingly, the functional coupling element can have a complementary second plug-in coupling part on the second interface part, in particular for forming a plug-in coupling. A plug-in coupling can be implemented in different ways, wherein some possible examples are described below with reference to embodiments of the invention.

Preferably, the first plug-in coupling part and the second plug-in coupling part can be plugged into one another along a plug-in axis and coupled to one another integrally for coupling the fluidic unit to the actuator unit, i.e. for forming the functional coupling.

For coupling purposes, at least one first latching element can be arranged on, preferably in, the first plug-in coupling part and/or at least one second latching element cooperating therewith can be arranged on, preferably in, the second plug-in coupling part.

In a (first) embodiment, the fluidic unit can be coupled to the actuator unit under at least two rotational positions around the plug-in axis via the coupling region for the change system. Accordingly, the change system, in particular the change manipulator, can preferably be designed to rotate the fluidic unit in the automated process about or between at least two rotational positions. Alternatively or additionally, the rotational movement could also take place via the second dosing head component or a dosing system.

The first and second latching elements can, for example, be designed such that the first plug-in coupling part and the second plug-in coupling part each have one or more elevations which interact like a bayonet lock. The elevations on the first plug-in coupling part and on the second plug-in coupling part can initially be pushed past one another like “teeth” in a first rotational position in relation to the plug-in axis, wherein then (as soon as the two plug-in coupling parts are arranged relative to one another as intended for coupling) the two plug-in coupling parts are rotated with respect to one another about the plug-in axis in such a way that the teeth engage behind one another.

However, it is also possible that one plug-in coupling part has corresponding projections and the other plug-in coupling part to have recesses that match them, for example at least one first channel running in the longitudinal direction of the plug-in axis on a plug-in coupling part and at least one matching elevation (or tooth) on the other plug-in coupling part, which runs in the channel when the plug-in coupling parts are plugged into one another, and a channel section adjoining the first channel which runs azimuthally around the plug-in axis in order to anchor the elevation therein by rotating the plug-in coupling parts against one another.

The basic principle of such a coupling mechanism in the form of a bayonet lock for a dosing valve is known from DE 10 2017 122 034 A1, the content of which is hereby incorporated into this application.

In a (second) embodiment, alternatively or additionally, the first plug-in coupling part and/or the second plug-in coupling part, preferably at least the second plug-in coupling part, can have an automatically movable locking mechanism. The locking mechanism is designed to move at least one latching element in a plug-in coupling part with respect to an associated latching element in the other plug-in coupling part by a certain distance, in particular actively, for coupling the fluidic unit with or to the actuator unit.

Preferably, the first plug-in coupling part can have a number of projections as a latching element. The second plug-in coupling part, which is particularly designed as part of an actuator unit, can as a second latching element, have a movable rotary plate. The rotary plate preferably has recesses complementary to the projections. Preferably, the rotary plate is designed to be movable in a direction orthogonal to the plug-in axis.

For coupling, the first plug-in coupling part can be inserted in the automated process via the coupling region for the change system along the plug-in axis into the second plug-in coupling part in such a way that the projections and the recesses engage with one another or are arranged to match one another. As soon as the first plug-in coupling part is positioned as intended with respect to the second plug-in coupling part, the rotary plate (as a latching element) can be moved or rotated with respect to the projections (as a latching element) in the first plug-in coupling part via the controllable locking mechanism, so that the projections and the recesses are displaced relative to one another or engage one behind the other for locking.

In a (third) embodiment, the first latching element can be realized on or in the first plug-in coupling part by means of a number of spherical caps and/or at least one groove running radially around a base body of the plug-in coupling part.

The second latching element on or in the second plug-in coupling part can have a number of balls corresponding to the number of spherical caps. The second latching element can preferably have a movable rotary plate with a number of intermittent projections and recesses corresponding to the number of balls. Preferably, the balls are mounted so that they can move.

For coupling the plug-in coupling parts, the recesses of the rotary plate and the balls can be arranged to match each other, i.e. respectively one ball is arranged in one recess of the rotary plate, so that the first plug-in coupling part can be inserted into the second plug-in coupling part, in particular by means of the change system. Via a locking mechanism of the second plug-in coupling part, the rotary plate (as a latching element) can be rotated with respect to the first plug-in coupling part in such a way that respectively one projection of the rotary plate is assigned to a ball, wherein respectively one ball is pressed into a spherical cap in the first plug-in coupling part. Preferably, the balls are spring-mounted and can be positioned via the locking mechanism in such a way that the balls engage in a recess or spherical cap of the first latching element with a defined force.

The locking mechanism can preferably be designed to move, preferably rotate, a first latching element and/or a second latching element at least in sections along a circular path. Accordingly, the locking mechanism can also be designated as a movement mechanism. In particular, the first and/or the second latching element can be rotated with respect to each other by a certain angle via the movement mechanism.

To move the latching element, the locking mechanism can have at least one actuator that can be controlled by the control device, in particular a controllable drive such as, for example, a magnetic drive or an electromagnetic actuator.

Advantageously, by designing a plug-in coupling based on the basic principle of a bayonet lock, a quick and reliable coupling or decoupling of two dosing head components during operation can be accomplished. Since only two components have to be brought into operative contact and possibly rotated for such a coupling, this type of coupling is particularly suitable for an automated coupling process according to the invention with the advantageous effects already described due to the time savings.

Advantageously, in embodiments (second and third) with at least one actively rotatable latching element, a rotary movement of the fluidic unit can be dispensed with, wherein the change system, e.g. the change manipulator can be designed to be structurally simpler. As a further advantage, the fluidic unit can be inserted into the actuator unit in a certain position and then locked in this position, e.g. by rotating the fluidic unit with respect to the plug-in axis by a certain angle with respect to the actuator unit during operation.

Preferably, in the described embodiments (one to three), the plug-in axis runs substantially parallel to an ejection direction of dosing material from a nozzle, in particular parallel to a direction of movement of an ejection element for dispensing dosing material.

Preferably, at least one plug-in coupling part, preferably at least the second plug-in coupling part, can have a controllable eccentric mechanism for locking the two plug-in coupling parts. Preferably, the eccentric mechanism can have at least one movable pressure element, wherein in order to lock the two plug-in coupling parts, in particular in the intended coupled state, a controllable drive can press the pressure element with a defined force into an associated recess in the second plug-in coupling part. The drive can be, for example, an electromagnetic actuator or a pneumatic actuator.

In a (fourth) embodiment of a plug-in coupling, the fluidic unit, in particular a first plug-in coupling part, can as a first latching element have at least one recess in a base body of the plug-in coupling part, in particular an annular groove, which preferably runs orthogonally to the plug-in axis. The plug-in axis here runs substantially parallel to the ejection direction of the dosing material. The second plug-in coupling part on or in the actuator unit can have, as a second latching element, a preferably linearly movable bearing element with a recess for the first plug-in coupling part. The bearing element is preferably designed such that it encloses the first plug-in coupling part at least in regions for coupling, in particular in a substantially form-fitting manner. Preferably, the bearing element engages in the annular groove in the first plug-in coupling part for coupling.

Preferably, the bearing element (as a latching element) can cooperate with a locking mechanism, wherein the locking mechanism is preferably designed to actively move the first latching element and/or the second latching element, preferably the second latching element, substantially linearly in at least one direction. Preferably, the second latching element, e.g. the bearing element, is movable in two opposite directions. For example, the bearing element could be realized as a movable slider with a recess, which can be moved linearly towards the first plug-in coupling part for coupling in a direction predominantly orthogonal to the ejection direction. For decoupling the fluidic unit, the slider could be moved away from the first plug-in coupling part in an opposite direction so that the annular groove in the first plug-in coupling part is released.

In a (fifth) embodiment of a plug-in coupling, the plug-in axis can run substantially orthogonally to an ejection direction of dosing material from the nozzle, in particular orthogonally to a direction of movement of an ejection element. Preferably, the first plug-in coupling part on the fluidic unit can have at least one, preferably two, projections as a latching element, in particular two elongated holding elements in the manner of a “tongue” of a “tongue-and-groove system”, which are arranged on opposite sides of the plug-in coupling part.

The second plug-in coupling part can have at least one, preferably two, grooves as a latching element, into which a tongue in the first plug-in coupling part engages, in particular in a form-fitting manner, to form the plug-in coupling. The plug-in coupling can then be designed in the manner of a, preferably double, “tongue and groove system”. Preferably, the first plug-in coupling part can be introduced into the actuator unit, in particular into the second plug-in coupling part, or pushed in laterally in a linear direction via the coupling region on the first dosing head component by means of the change system.

To lock the fluidic unit during operation, for example, a spring-mounted bolt can be provided as a further latching element in one of the plug-in coupling parts, which is preferably in operative contact with the other, preferably the first, plug-in coupling part in a direction predominantly orthogonal to the plug-in axis, i.e. predominantly parallel to the ejection direction.

It is also possible that the second plug-in coupling part has a locking mechanism which can move a fastening means as a (further) latching element in a linear direction, e.g. a bolt that can move in two opposite directions. For locking the two plug-in coupling parts, the bolt can be moved via a controllable drive of the locking mechanism, e.g. a magnetic drive, an electromagnetic servomotor or a pneumatic actuator, linearly towards the first plug-in coupling part and could, for example, engage in a designated recess.

In a (sixth) embodiment, the first and the second plug-in coupling part can be designed in the manner of a pneumatic quick-change coupling. Preferably, the plug-in axis can be substantially parallel to the ejection direction or the direction of movement of an ejection element. Preferably, the first plug-in coupling part has a number of recesses and/or openings in the base body as latching elements. The second plug-in coupling part has a matching number of latching elements, in particular linearly movable (safety) balls, wherein in the coupled state respectively one latching element, in particular one ball, engages in an associated recess. Preferably, the balls can be spring-mounted. In particular, the second plug-in coupling part can comprise a (ball) locking mechanism which is acted upon by means of at least one spring in order to press the latching elements, in particular the balls, (by means of spring force) into a respectively associated recess, in particular into an end position.

The second plug-in coupling part and/or the actuator unit can have, as part of the locking mechanism, at least one controllable pneumatic actuator which is designed to apply pressure medium to the (ball) locking mechanism in order to decouple the first plug-in coupling part, in particular to move the (ball) locking mechanism in a direction counter to a spring force, so that the recesses in the second plug-in coupling part are released.

As soon as the first plug-in coupling part is positioned as intended in the actuator unit, preferably via the change system, the pressure application can be terminated, wherein the second latching elements, preferably the safety balls, are pressed into the recesses for coupling, in particular by means of the spring force of a spring acting on the associated (ball) locking mechanism.

Alternatively or additionally, the first plug-in coupling part can have at least one, preferably two or more, in particular linearly movable locking bolts as a latching element. Preferably, the respective latching bolts are spring-mounted, in particular by means of a spring acting on the respective latching element. Preferably, the latching bolts are arranged and/or movable substantially orthogonally to the ejection direction of the dosing material. For coupling, the preferably spring-mounted latching bolts can be supported against the second plug-in coupling part and/or can each engage in an associated recess in the second plug-in coupling part.

Advantageously, in the previously described examples of plug-in couplings (embodiments 4 to 6) a particularly simple and quick coupling or decoupling of dosing head components during operation can be accomplished with the advantages already described. Due to the comparatively simple coupling mechanisms, the structural requirements for the change system can be kept as low as possible. Further advantageously in the case of plug-in couplings with a linearly movable latching element, especially with spring-mounted latching elements, is that the structural requirements for the plug-in coupling parts themselves can be kept comparatively low, which makes the dosing head components more cost-effective overall.

Further advantageously, via the arrangement of the locking mechanism in the second plug-in coupling part, regardless of the precise construction, the functional coupling can be provided more favourably overall since for example, the locking mechanism is only required once per actuator unit and does not have to be designed separately for each fluidic unit, which is advantageous since the fluidic system typically has to be changed more frequently.

The fluidics can preferably be designed in such a way that after decoupling the fluidics from an actuator unit, an ejection element, usually a plunger, of the fluidics unit is automatically pressed into a sealing seat of a nozzle and closes it (“normally closed”). For this purpose, for example, the ejection element must be spring-mounted.

Alternatively or additionally, the ejection element, particularly in the case of a “normally open” fluidic system, can be pressed, preferably actively, into a sealing seat of the nozzle by a (closing) mechanism in the change system, particularly also in the magazine, after decoupling the fluidic system from an actuator unit in order to prevent the dosing medium from escaping.

Alternatively or additionally, particularly in the case of dosing valves with a “normally open” fluidic system, a nozzle opening of the fluidic unit can be closed during a change and/or in the magazine, preferably actively, by a closure element, preferably from the outside. For example, a sealant can be actively pressed against a nozzle opening by means of the change manipulator or the magazine. For this purpose, the change system can be supplied with corresponding control signals via the control device in the automated coupling process. Alternatively, the sealing could also be achieved using spring force.

As described initially, alternatively or additionally, a locking coupling for a media line and/or a media pressure line (for a dosing material cartridge) can be provided so that the media-carrying area of the fluidics is closed off from the outside even when in the decoupled state. The locking coupling is preferably formed as part of the supply coupling element in the first interface part.

Furthermore, it would also be possible to substantially completely dose the dosing material out of the fluid system before changing the fluid system and/or to actively return the dosing material from the fluid system to an external media storage device, e.g. by means of negative pressure. The emptying of the fluidic unit or the return of dosing material to a storage device can be integrated as a process step in the process for automated coupling.

Advantageously, a particularly clean change of fluidics can be accomplished thereby, with as little dosing material as possible being lost unused.

In some cases it is desirable not to replace the entire fluidic unit but only a specific part thereof. In order to achieve this, a first interface part with a first functional coupling element can be assigned to a nozzle of a dosing head or a dosing system, in particular arranged on a nozzle. Preferably, a second interface part with a complementary second functional coupling element can be assigned to a fluidic base body of the same dosing head or the same dosing system and/or the same nozzle, in particular can be arranged thereon.

Preferably, the first interface part and/or the second interface part, in particular both parts, are designed to detachably, at least indirectly, couple at least one nozzle element or a nozzle part as the first dosing head component to or on the actuator unit and/or to or on the fluidic base body, in particular to form the fluidic unit, and/or to or on the nozzle via an interaction between the first and the second functional coupling element.

This means that only a specific part element of a nozzle or an entire nozzle can be replaced. Accordingly, at least a part of a fluidic unit, in particular the fluidic base body, is not replaced. In particular, during the coupling and/or decoupling of at least one nozzle part, at least a part of the same fluidic unit, i.e. the fluidic base body, can be coupled to an associated actuator unit, which is preferably arranged on a dosing device. Accordingly, in these embodiments, i.e. when at least one nozzle element is changed as the first dosing head component, a supply coupling can preferably be dispensed with, since the remaining media-carrying part of the fluidic unit, i.e. the fluidic base body, is arranged on the actuator unit or remains there during the component change. Accordingly, the first and second interface parts can then each be formed as one piece.

In a (seventh) embodiment, an (entire) nozzle can be changed as the first dosing head component. A “nozzle” is understood to be a part of the fluidic system that is designed to discharge dosing material from a dosing valve. A nozzle has at least one nozzle opening as an outlet opening for dosing material and a hollow nozzle chamber for dosing material adjoining it towards the inside. In jet valves, a movable ejection element (not part of the nozzle) can be arranged in the nozzle chamber, which is pushed forward at high speed towards the nozzle opening to dispense dosing material. To eject from the nozzle, the ejection element or the plunger comes into contact with the dosing material to be dispensed and “presses” or “pushes” the dosing material out of the nozzle of the dosing system due to a movement of the ejection element and/or the nozzle. By means of the ejection element, the dosing material is “actively” ejected from the nozzle. Particularly in the case of jet valves, the nozzle frequently has a sealing seat in the area of the nozzle opening, into which the ejection element for dispensing the dosing agent is pressed with a certain force, whereby the nozzle opening is briefly closed. A nozzle can also include other elements, such as for example, elements for cooling and/or heating dosing material in the nozzle chamber.

Preferably, the functional coupling element of the first interface part can have a first plug-in coupling part and the functional coupling element of the second interface part can have a second complementary plug-in coupling part. Preferably, the first plug-in coupling part and the second plug-in coupling part can be plugged into one another along a plug-in axis and coupled to one another integrally for coupling at least one nozzle element with or to the fluidic base body or to the fluidic unit. For coupling, at least one first latching element can be arranged on, preferably in, the first plug-in coupling part and/or at least one second latching element cooperating therewith can be arranged on, preferably in, the second plug-in coupling part.

For example, a (complete) nozzle itself can form the first plug-in coupling part, wherein the second plug-in coupling part is configured part of the (remaining) fluidics, in particular as part of the fluidic base body. Preferably, the first and second plug-in coupling parts can cooperate in the manner of a bayonet closure to couple a nozzle to the fluidic unit.

The formation of a plug-in coupling for coupling a (complete) nozzle to the fluidic unit, in particular to the fluidic base body, to form a dosing head can be carried out according to the same mechanisms as previously described using the fluidic unit as the first dosing head component. An adaptation is only made in such a way that the first plug-in coupling part is preferably designed as part of the nozzle, wherein the second plug-in coupling part and any locking mechanisms are preferably designed as part of the remaining fluidic unit, in particular the fluidic base body. Furthermore, the mechanisms for plug-in couplings described in embodiments one to six can also be transferred to the reversible coupling of a nozzle (as the first dosing head component) to a fluidic unit, in particular to a fluidic base body (as the second dosing head component). Since at least parts of the fluidic unit, i.e. the fluidic base body, are preferably coupled to an actuator unit during a change of at least one nozzle part, a nozzle element can also be coupled (at least indirectly) to an actuator unit via the interface.

For example, a nozzle as a first plug-in coupling part can be coupled to the second plug-in coupling part under at least two rotational positions around a plug-in axis via a coupling region for the change system. Preferably, the change system can be designed, for example, via a suitable access element to rotate the nozzle by at least two rotational positions about the plug-in axis. The change system can for example, have differently designed access elements to specifically interact either with a nozzle or with a fluidic unit for coupling.

However, it is preferred that the change system, in particular the change manipulator, has one or more “universal” access elements. Preferably, the change system can be adapted to differently designed coupling regions of different dosing head components. In particular, an adjustment can be made via a control by the control device in the automated change process. For example, the change system can have one or more pneumatic grippers.

Alternatively or additionally, the first interface part and/or the second interface part can have an automatically (actively) movable internal locking mechanism, e.g. a controllable actuator. The locking mechanism can preferably be designed to couple or decouple a nozzle that is arranged opposite the fluidic unit as intended. The locking mechanism could be implemented in one of the ways described previously or could produce a rotary or screwing movement of the nozzle for the change.

It is also possible that the nozzle is designed to be pluggable as intended onto the fluidic unit, in particular the fluidic base body, and is then mounted by means of a nozzle fixing nut for coupling to the fluidic unit or the fluidic base body, in particular by means of a screw connection. In this case, the first and/or the second functional coupling element could be designed in multiple parts.

It is also possible that the first dosing head component is realized in the form of a nozzle casing (as a nozzle element) which has an internal thread as the first interface part, in particular as the first functional coupling element. In this embodiment, only a part of the nozzle is changed, whereby the fluidic base body, in particular the remaining nozzle parts such as a nozzle base body, form the second dosing head component. Preferably, a nozzle base body arranged on the fluidic base body can have a complementary external thread as a second functional coupling element in order to mount the nozzle casing as intended. In this case, the respective functional coupling element can correspond to the respective interface part.

For example, the change system could be designed and thus access the coupling region in such a way that the change system, preferably a change manipulator, performs a screw or rotary movement of the nozzle casing and/or a nozzle fixing nut in relation to the (remaining) fluidic unit or the fluidic base body and/or the actuator unit for changing (“external changer”). For example, the nozzle casing as a coupling region for the change system can have a certain, e.g. hexagonal external shape, wherein the change manipulator (as access element) has a corresponding recess for a positive connection and wherein the change manipulator performs a rotary movement of the nozzle casing for coupling and/or decoupling.

Advantageously, with such a dosing head a rapid, automated change of nozzle parts or an entire nozzle can be accomplished, which is desirable in operation since a nozzle typically has to be cleaned more frequently than other components of a fluidic unit. This is due, for example, to the fact that a nozzle clogs up more rapidly than other parts of the fluidic system due to its geometry, in which case the dosing precision can change undesirably. Changing the nozzle can also be necessary if a different dosing pattern is required, e.g. in relation to the nozzle geometry or diameter. As a result of the automated change, the set-up time of the dosing device can be significantly shortened.

Advantageously, the automated nozzle change can also be used profitably when determining parameters for a dosing process, e.g. when several different nozzles are tested to obtain an optimal dosing result. Since manual changing is time-consuming, time can be saved with the automated nozzle changing. Further advantageously the automated nozzle change can be integrated into automatic measurement series for parameter determination if the respective dosing pattern, for example, is evaluated by a camera system.

In the case of jet valves, automated nozzle changing can also be used profitably when processing abrasive media with high wear in the impact area of an ejection element. For example, the nozzle, in particular a sealing seat, can be made of a relatively soft material, which is inexpensive to manufacture, and the ejection element can be made of a harder material, so that most of the abrasion occurs in the area of the nozzle and the ejection element is protected. The nozzle or a nozzle casing can be replaced in a short time via the corresponding interfaces. In the case of jet valves, due to the interaction of the two interface parts and the interaction with the change system in the automated change process it is also ensured that a new nozzle is positioned concentrically with respect to an ejection element after coupling.

In an (eighth) embodiment, the nozzle element to be replaced, i.e. the first dosing head component, can comprise a nozzle aperture, in particular the first dosing head component can be designed as a nozzle aperture. Preferably, the nozzle aperture comprises a first interface part with a first functional coupling element, wherein a second interface part with a complementary second functional coupling element is arranged on the same nozzle, in particular on a nozzle base body. In this embodiment, a sub-compartment of a nozzle can therefore be changed, wherein another part of the nozzle is arranged on a fluidic unit, in particular on the fluidic base body, for or during the coupling and/or decoupling. The fluidic base body can preferably be coupled to an actuator unit during the change and/or arranged on a dosing device.

A nozzle aperture is understood to mean in particular a part of a nozzle which comprises a nozzle opening. Preferably, the nozzle aperture can form the nozzle opening. Preferably, a nozzle aperture comprises at least one nozzle aperture opening for the discharge of dosing material from the nozzle of a dosing head (in the coupled state) and/or a sealing seat of the nozzle. Preferably, a nozzle aperture can be designed as a nozzle insert.

Preferably, the nozzle aperture itself can form the first interface part. Depending on the embodiment, a bearing part for holding a nozzle aperture can also form at least part of the first interface part. The second interface part on the nozzle, in particular on the nozzle base body, can preferably be designed as a receiving area or an insertion area for the nozzle aperture. For example, the second interface part can be designed by means of a slot such that the nozzle aperture can be at least partially introduced into the nozzle or the nozzle base body via the inlet slot.

In order to couple the nozzle aperture as the first dosing head component via the interface to the other part of the nozzle, in particular the nozzle base body as the second dosing head component to form a functional nozzle, the first interface part, in particular a first functional coupling element and/or the second interface part, in particular a second functional coupling element, can each have a sliding seal as a component of the interface.

Preferably, the nozzle aperture can be introduced into a nozzle in an automated process by means of a controllable aperture change system, which is designed as a subcomponent of a change system. Preferably, an introduction direction of the nozzle aperture into the nozzle (nozzle base body), in particular for forming the nozzle, via the aperture change system can be transverse, i.e. substantially orthogonal, to an ejection direction of dosing material from the nozzle. In particular, the direction of insertion can be substantially orthogonal to an ejection movement direction of the ejection element in the nozzle.

The aperture change system can be connected, preferably detachably, to a fluidic unit assigned to the nozzle, in particular a fluidic base body, and/or to an actuator unit and/or to a dosing device.

Preferably, the aperture change system has a controllable, automatically movable locking mechanism which is designed to introduce at least one nozzle aperture into the nozzle, preferably by means of a linear movement and/or along a circular path. The term “introduction into the nozzle” is generally understood to mean that the nozzle aperture is positioned with respect to the nozzle, in particular a nozzle base body, for coupling in such a way that a functional nozzle is formed. For example, the nozzle aperture could also be “introduced” into the nozzle in such a way that the nozzle aperture forms a kind of attachment for the nozzle base body or lies sealingly on the outside of the base body in order to close off a nozzle chamber thereabove.

To move the nozzle aperture, the locking mechanism has at least one controllable actuator, e.g. a pneumatic actuator, a magnetic drive or an electromagnetic servo motor.

Preferably, in one embodiment, a nozzle aperture can be held in a separate bearing part for coupling and/or during operation of a dosing head. Preferably, a nozzle aperture, in particular a nozzle insert, engages in a form-fitting manner in an associated recess in the bearing part. Preferably, an outer shape of a nozzle aperture can form a coupling region which is designed to interact with the aperture change system, in particular via the bearing part as an intermediate member.

The bearing part can preferably be formed as part of the aperture change system and/or as part of the first interface part. For coupling and/or decoupling the nozzle aperture, the bearing part and the actuator can preferably engage with each other in a form-fitting manner in order to achieve particularly precise positioning of the nozzle aperture.

Preferably, a nozzle aperture can be positioned in a nozzle base body via the locking mechanism for coupling such that a nozzle aperture opening is arranged concentrically opposite a tip of an ejection element during operation. Depending on the configuration, the locking mechanism itself can form the aperture change system.

The aperture change system can further comprise a nozzle aperture magazine for, in particular with, at least one, preferably for, in particular with, two or more separate nozzle apertures. The aperture change system with the locking mechanism and the nozzle aperture magazine can preferably be arranged on the fluidic unit or on the fluidic base body and are preferably designed as a unit. Accordingly, the terms “internal aperture change system” or “internal magazine” could also be used.

Preferably, at least two nozzle apertures of the same nozzle aperture magazine can have a different design, e.g. with regard to the nozzle geometry and/or the material. Preferably, the aperture change system is controllable and designed to introduce a specific nozzle aperture, preferably one corresponding to the respective dosing requirements, into the nozzle or the nozzle base body.

In one embodiment, the nozzle aperture magazine can be formed by means of a preferably one-piece nozzle aperture device, which is also referred to as a “nozzle aperture assembly”. Preferably, such a nozzle aperture assembly can have two or more separate nozzle aperture openings, wherein the respective nozzle aperture openings can be designed differently. For example, the nozzle aperture assembly could be an elongated, e.g. flat or sheet metal with a plurality of linearly arranged nozzle aperture openings or a disk with a plurality of circularly arranged nozzle aperture openings (in the manner of a perforated disk). Accordingly, the individual nozzle apertures can then be realized by means of the respective nozzle aperture openings of the nozzle aperture assembly.

However, it is preferred that a nozzle aperture, e.g. a nozzle insert, for coupling and/or in the coupled state is held by means of a bearing part on and/or in a nozzle base body. In this embodiment, a nozzle insert (as the first component) that is formed separately with respect to the bearing part can be introduced into an associated nozzle aperture receptacle or holder in the bearing part by means of the aperture change system and/or by means of a change manipulator. The bearing part can then be inserted into the nozzle base body by means of the locking mechanism, forming an interface for coupling the nozzle aperture. In particular, the nozzle aperture is attached to the nozzle base body for coupling from the outside via the bearing part. Preferably, the nozzle aperture can be moved in a linear direction towards or away from the nozzle base body.

For decoupling, an “old” nozzle aperture can be pushed out of the nozzle body again via the bearing part, preferably from the side. Preferably, a nozzle aperture can be deposited in a defined storage area after a decoupling in the automated process. Preferably, the nozzle aperture can be taken over in the decoupled state, in particular from the storage part, by a change manipulator and transferred to a storage area. In principle, it would also be possible for this transfer to the storage area to take place by means of the aperture change system. The storage area can, for example, comprise a cleaning bath, so that subsequent cleaning of the nozzle aperture is advantageously facilitated.

Particularly preferably, the change manipulator and/or the aperture change system can equip a free, in particular a recently freed, nozzle aperture holder in the bearing part with a “new” nozzle aperture, wherein the bearing part and above it in particular the nozzle aperture can be reinserted into the nozzle base body for coupling by means of the aperture change system.

Particularly preferably, a nozzle aperture magazine can comprise a bearing part which can be equipped with a plurality of one-piece, separately formed nozzle apertures or nozzle inserts, in particular is equipped therewith. Preferably, during operation of a dosing head, respectively one nozzle aperture can be arranged in a nozzle aperture holder in the bearing part (unless a nozzle aperture is being changed). Preferably, the nozzle apertures in a bearing part (as part of the nozzle aperture magazine) can have a different design. For example, the bearing part can be an elongated, flat sheet or a disk with a number of nozzle aperture holders for nozzle apertures.

Preferably, the aperture change system is designed to insert a specific nozzle aperture from the internal magazine into the nozzle base body or to arrange it on the nozzle base body via the locking mechanism and the interface to form a nozzle. For example, a certain nozzle aperture can be arranged by means of a linear, e.g. lateral (sliding) movement and/or a rotary movement, preferably from the outside on the nozzle body. For a nozzle aperture magazine with a bearing part, it is also possible that a first nozzle aperture is coupled as intended to the nozzle base body (via the bearing part), wherein a second nozzle aperture (simultaneously) is removed from the bearing part by means of a change manipulator and/or is replaced by another nozzle aperture in an automated process.

Preferably, the locking mechanism—regardless of the specific design—is designed to be controllable by a control device such that a specific nozzle aperture, in particular a nozzle aperture with a specific nozzle aperture opening, can be introduced into the nozzle from a nozzle aperture magazine by means of a linear movement and/or along a circular path, in particular can be coupled thereto.

The advantageous effects of a dosing head for an automated change of a nozzle aperture largely agree with the previously described advantages, which also result from changing the entire nozzle. An additional advantage arises when the nozzle aperture and/or the nozzle aperture assembly are made of a material that is softer than the material of an ejection element. Accordingly, only a comparatively small part of a nozzle needs to be replaced, wherein, for example, the base body of the nozzle can remain in operation for longer.

Particular advantages of a dosing head that is designed for an automated change of a nozzle aperture are obtained in dosing processes in which, for example, due to the dosing configuration, a change of the nozzle aperture takes place particularly frequently. Since the aperture change system with the aperture magazine can preferably be carried directly on the fluidic unit, a nozzle aperture change can be carried out in any position of a dosing head or nozzle head or manipulator, so that process time is saved. A particular time saving also results from the fact that a nozzle aperture, e.g. a nozzle aperture assembly or a bearing part, only needs to be moved by a few millimetres. Further advantageously in the case of a purely static (stationary) dosing device, an additional change system, e.g. a movable change manipulator to bridge a distance between the dosing head and an external magazine could be dispensed with since the change process can only be carried out via the accompanying aperture change system.

To ensure that no dosing medium escapes from the fluidic base body when changing a nozzle aperture or an (entire) nozzle during the change process, at least one functional coupling element can have a sliding seal. Alternatively or additionally, steps can be implemented in the change process that can additionally prevent an unwanted escape of dosing medium. For example, before decoupling a first dosing head component, the dosing medium can be depressurized, at least in the dosing head. Alternatively or additionally, the dosing medium can be moved away from at least the nozzle, in particular from the nozzle insert, preferably actively, e.g. by applying a vacuum. Furthermore, a media supply can be interrupted, wherein the residual material (located in the nozzle) exits the nozzle by means of gravity and/or wherein at least the nozzle is rinsed, preferably before decoupling. Attention is drawn to the fact that the steps described can be integrated into the change process regardless of the specific dosing head component to be replaced, e.g. also in a fluidics as the first component.

In order to achieve a certain dosing precision after replacing at least one nozzle part and/or an entire fluidic system during operation, it may be necessary, particularly in the case of jet valves, to (re-)adjust the actuator unit or the dosing head. Accordingly, in a jet valve, a (working) actuator can be designed such that it can be adjusted in an automated process such that in a defined operating state of the actuator, in particular in a deflected operating state, a certain contact pressure of an ejection element in a nozzle is generated via the actuator during operation of the dosing head.

In a jet valve with a piezo actuator as (working) actuator, the actuator unit can preferably have a controllable adjustment actuator for setting a contact force of an ejection element in the nozzle. Preferably, the adjustment actuator is designed to set a specific position of the (working) actuator in relation to an actuator housing and/or to the ejection element. Preferably, the adjustment actuator can be designed to be controllable in such a way that an arrangement comprising the (working) actuator, the ejection element and the nozzle can be adjusted in the desired manner such that a certain pressing force of a tip of the ejection element into a sealing seat of the nozzle is brought about.

For a jet valve with a different type of actuator type, e.g. a pneumatic actuator or an electromagnetic drive, the respective actuator can preferably be designed to be controllable, in particular by a higher-level control device, such that in a defined operating state of the actuator a certain contact force of an ejection element into a nozzle is generated via the actuator.

Advantageously, manufacturing tolerances in the fluidics unit can be compensated for using automatically adjustable actuators, so that a high dosing precision can be achieved after a fluidics change. Since an adjustment process can be carried out fully automatically via the control device, no manual adjustment is required, so that the time between coupling a “new” component and resuming dosing operation is as short as possible. Adjustable actuators and corresponding adjustment procedures for dosing valves are known, for example, from DE 10 2019 121 679 A1, the content of which is hereby incorporated into this application. The adjustment of at least one actuator can preferably be a method step in the method for automated coupling.

In a (ninth) embodiment of the invention, a first interface part with at least one first functional coupling element can be assigned to, in particular arranged on, a dosing material supply that can be carried along during operation. A second interface part with a complementary second functional coupling element can be assigned to the fluidic unit, in particular arranged thereon. Preferably, the first interface part and/or the second interface part, in particular both, are designed to detachably couple at least the dosing material supply with or to the fluidic unit via an interaction between the first and the second functional coupling element.

The dosing material supply can preferably be a cartridge with dosing material or dosing medium that is carried along by the dosing system during operation of the dosing system. Preferably, the interface can be formed by means of a rotary or screw connection. The first interface part could, for example, be realized by means of an internal thread in the area of the cartridge and the complementary second interface part could be realized with a suitable external thread on the fluidics. In order to replace the cartridge in the automated process, the cartridge preferably has a coupling region which is designed to functionally interact with the change system of the dosing installation. Changing a cartridge can preferably be carried out by means of the movable change manipulator, which is designed in particular for a rotational movement of the cartridge in different directions. Preferably, the access element of the change manipulator for changing a cartridge is adaptable to a coupling region of a cartridge. Alternatively, the cartridge could also be plugged onto the fluidics for coupling.

In this embodiment, the first and the second interface part are preferably each formed in multiple parts and (additionally) preferably comprise at least one further interface element, each with a supply coupling element for forming a supply coupling. A supply coupling can be designed as described initially. Preferably, at least one supply line of the cartridge can be functionally coupled to an associated line in the second interface part via the supply coupling, wherein a dosing medium in the cartridge can be subjected to pressure (supply pressure) via the supply coupling.

Preferably, the (same) access element of the change manipulator can be designed such that it is designed, preferably under appropriate control by a control device, for changing a fluidic unit and/or a fluidic base body and/or at least one nozzle part and/or a portable dosing material supply. Preferably, a gripper of the access element can have differently designed (coupling) areas in order to functionally interact with the respective dosing head components. Furthermore, the gripper can have one or more gripping tongs which are adapted to differently designed coupling regions and/or wherein a configuration of a gripping tong is adjustable during operation, in particular complementary to a specific coupling region, preferably by means of control by the control device.

It is pointed out that within the scope of the invention the terms “first” and “second” dosing head component can be used interchangeably depending on the situation. In particular, the terms are not limited to the previously described specific combinations of two dosing head components, but the terms may have a different meaning depending on the specific installation situation. For example, in the automated process, a complete fluidic unit can be coupled as the first component with an actuator unit as the second component. On the other hand, an entire nozzle can be replaced as the first dosing head component, possibly even without resuming dosing operation, wherein the same fluidic unit in this combination is then the second dosing head component. Furthermore, a nozzle aperture can be replaced as the first component, whereby the same nozzle or the same base body in this combination is the second component.

The invention is explained in more detail hereinafter with reference to the accompanying figures using exemplary embodiments. In the various figures, the same components are provided with identical reference numbers. In the figures:

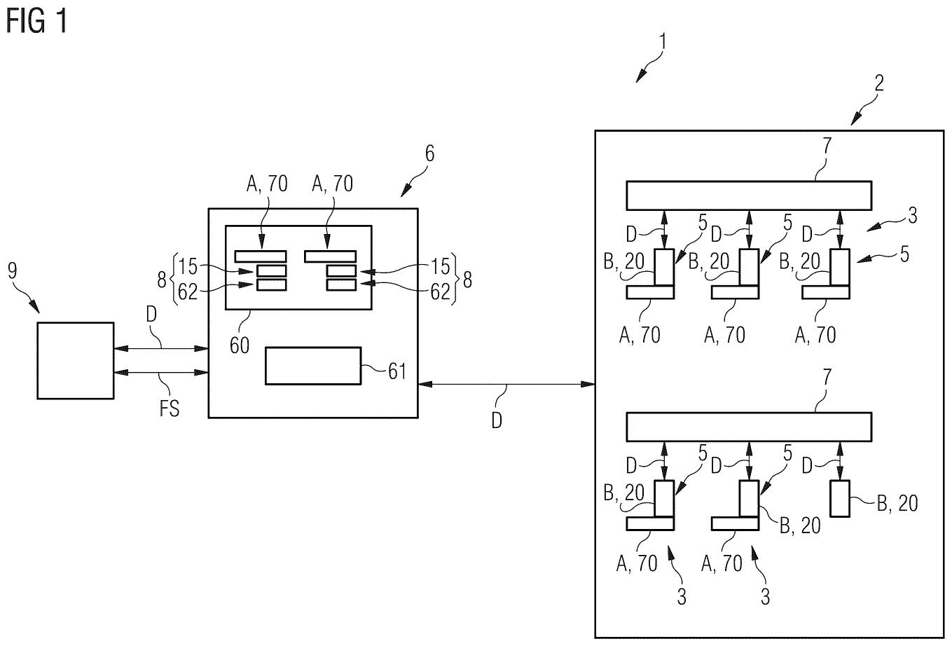

FIG. 1 shows a schematic representation of a dosing installation according to the invention,

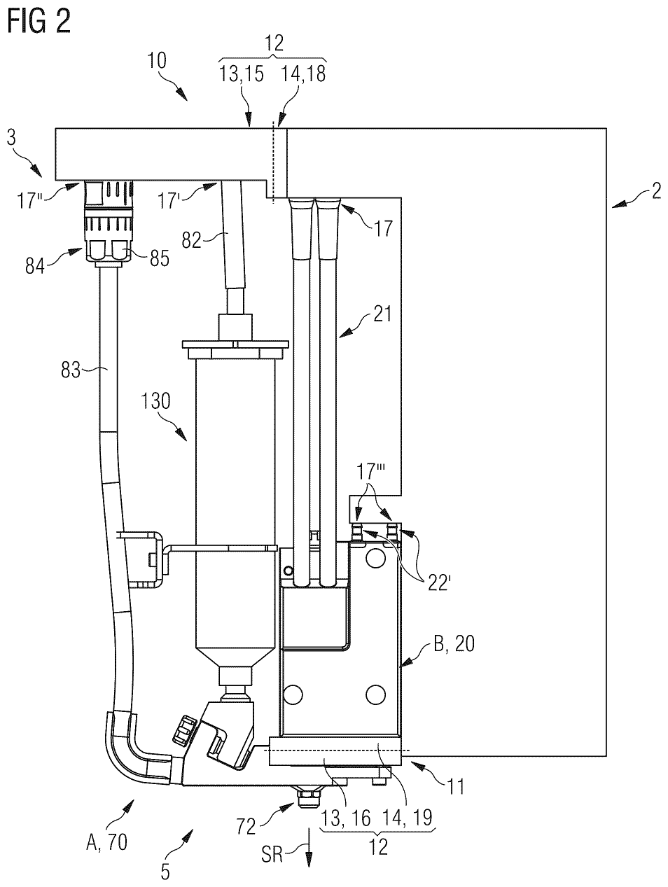

FIGS. 2 to 5 show schematic representations of different dosing systems according to the invention,

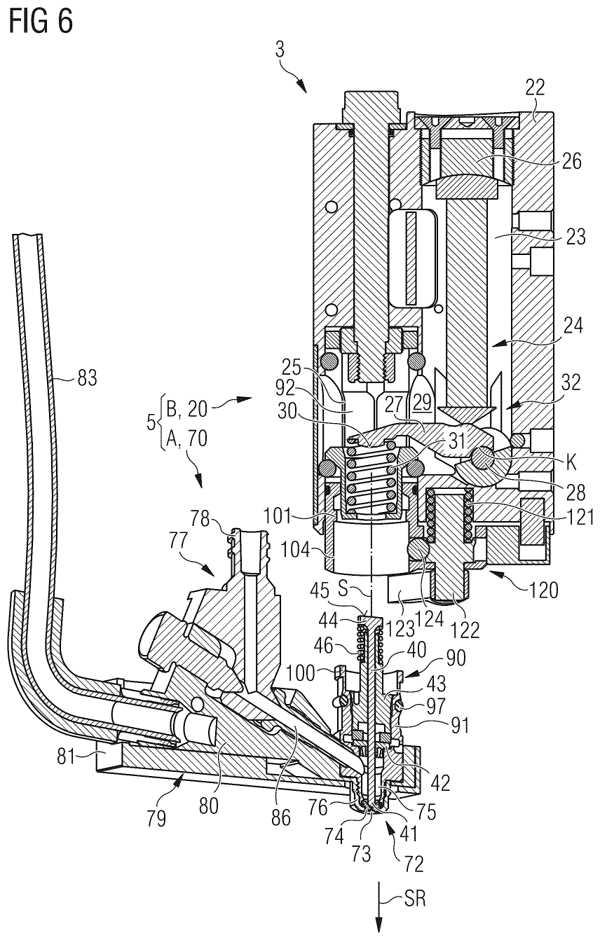

FIG. 6 shows a sectional view through parts of a dosing system according to the invention,

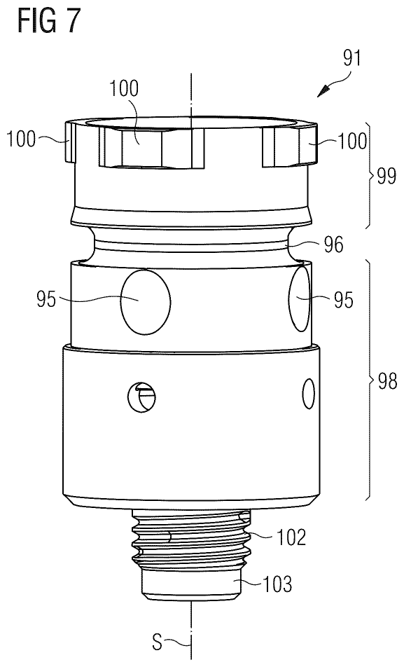

FIG. 7 shows a part of a first plug-in coupling part,

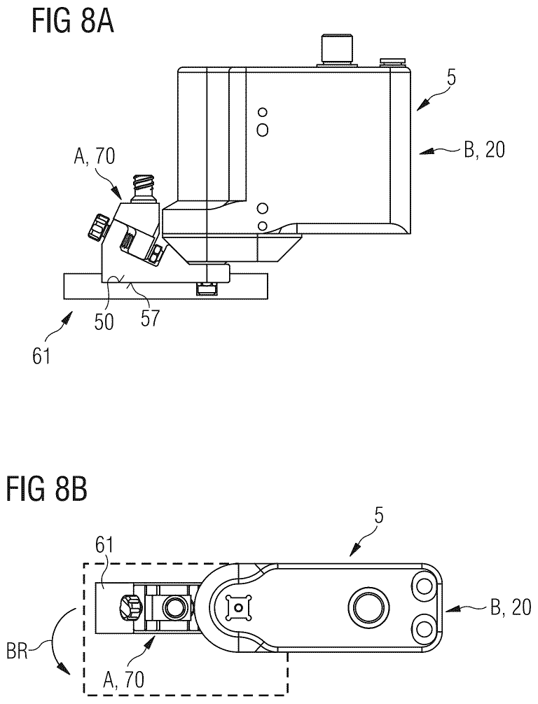

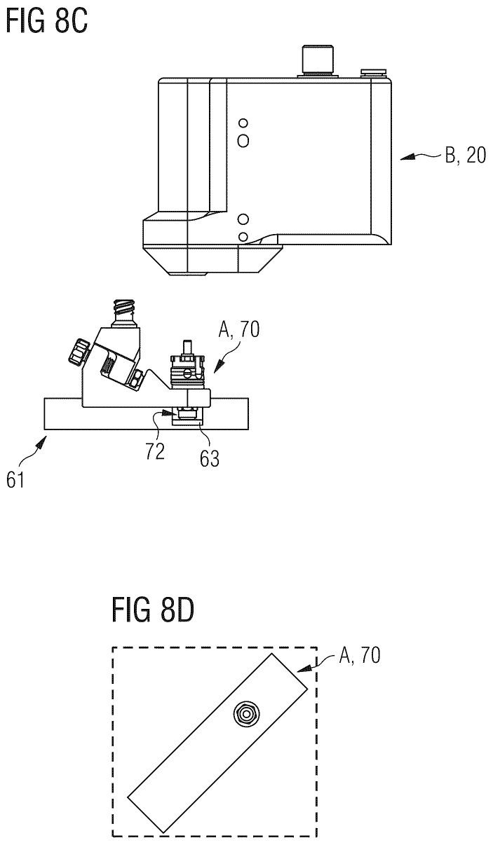

FIG. 8 shows a schematically depicted decoupling process according to the invention,

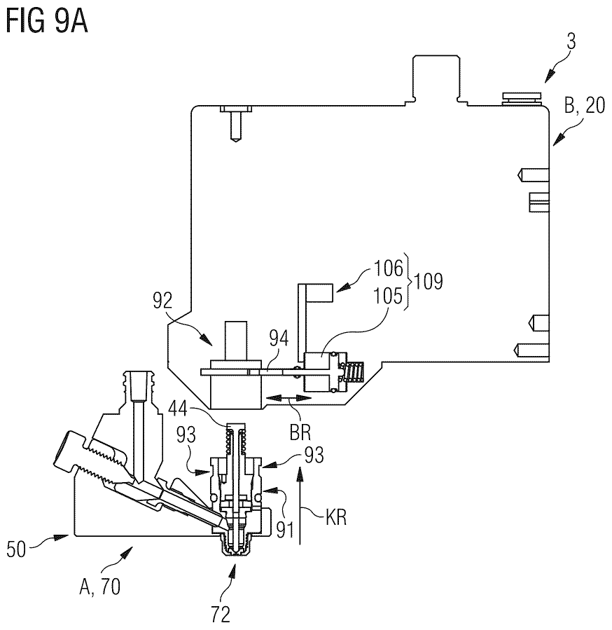

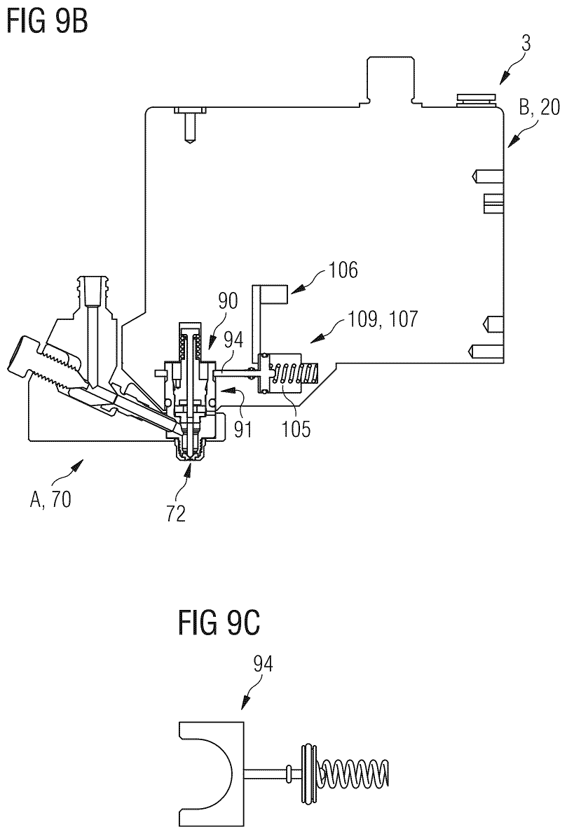

FIG. 9 shows sectional views of parts of a dosing system with a plug-in coupling according to the invention,

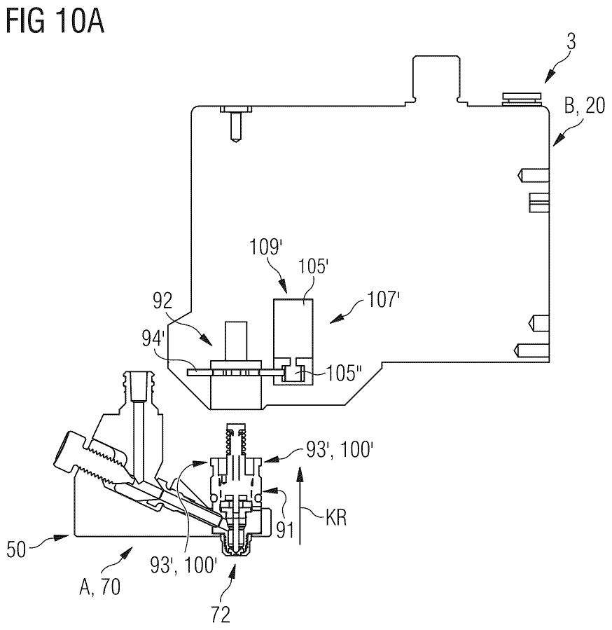

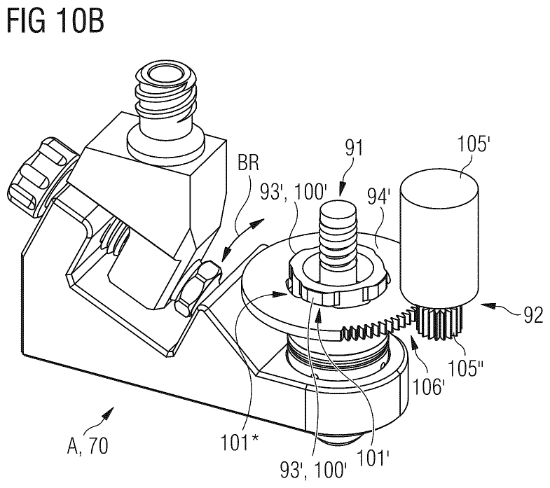

FIG. 10 shows a sectional view of parts of a dosing system and an enlarged view of parts of a plug-in coupling according to the invention,

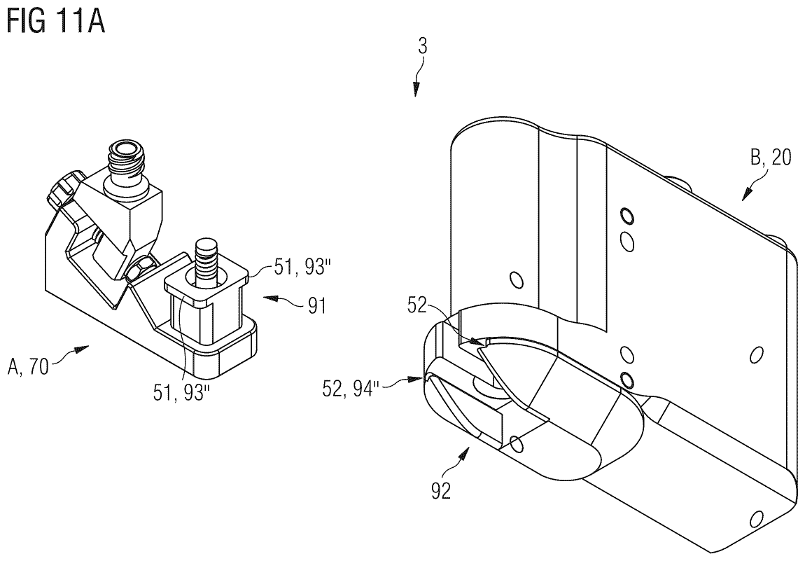

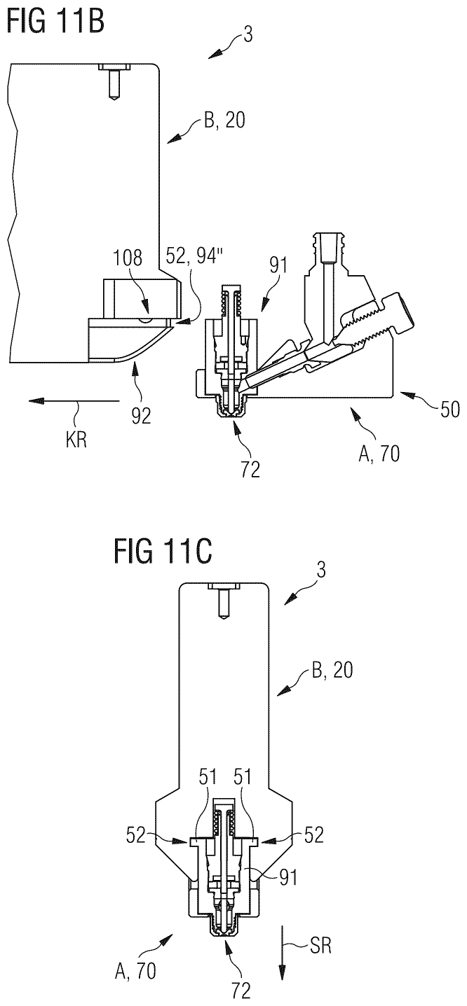

FIG. 11 shows sectional views and perspective views of parts of a dosing system with a plug-in coupling according to the invention,

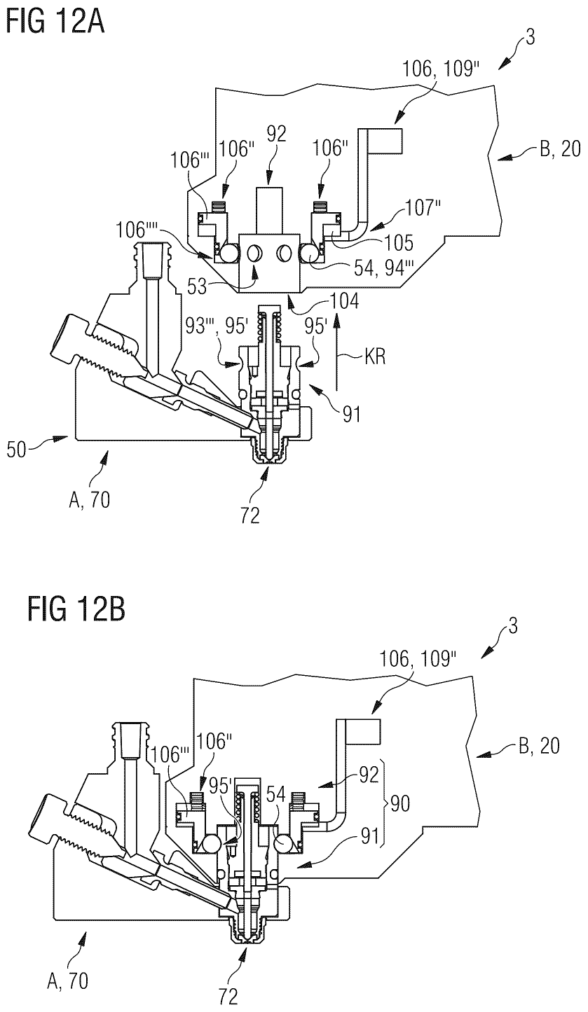

FIG. 12 shows sectional views of parts of a dosing system with a plug-in coupling according to the invention,

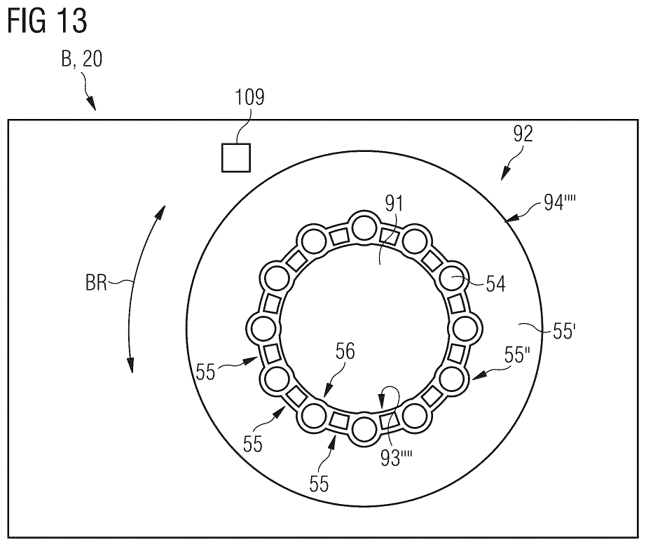

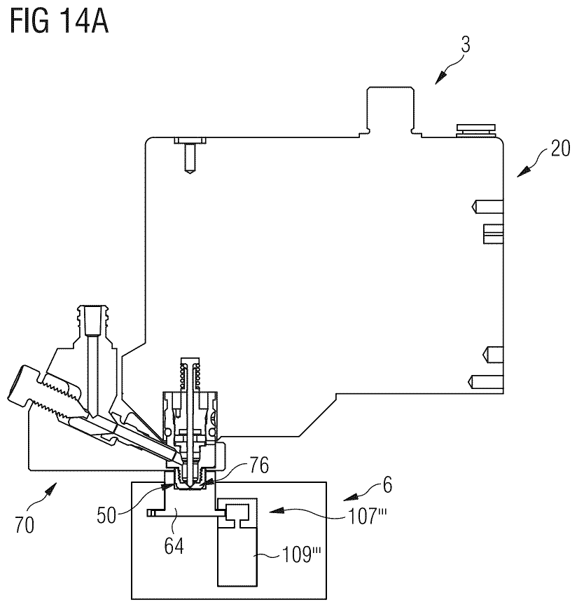

FIG. 13 shows a schematic section through a plug-in coupling according to the invention,

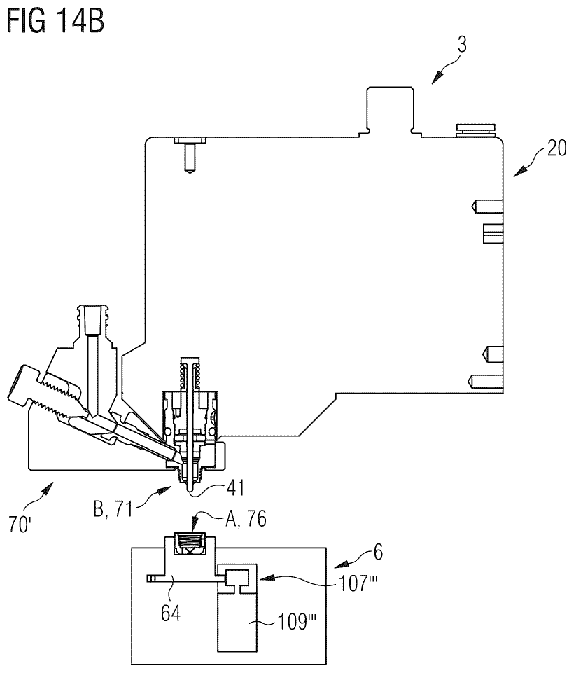

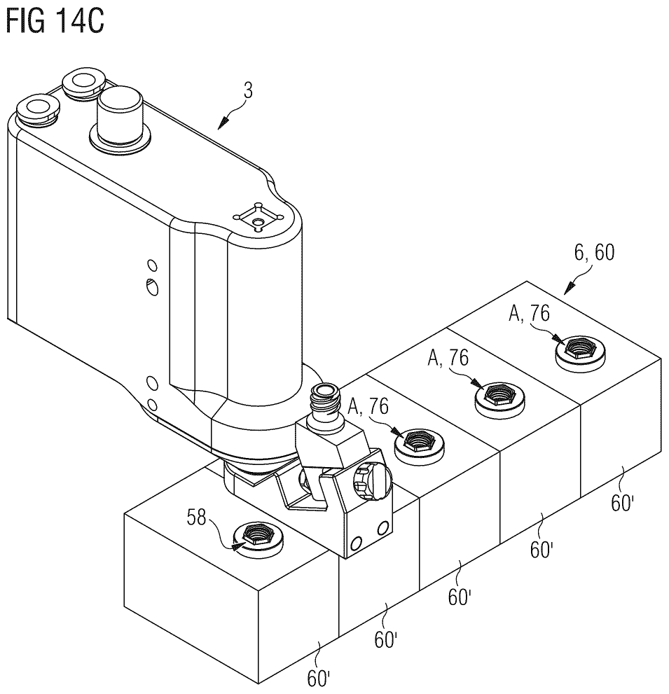

FIG. 14 shows sectional views and a perspective view of parts of a dosing system according to the invention,

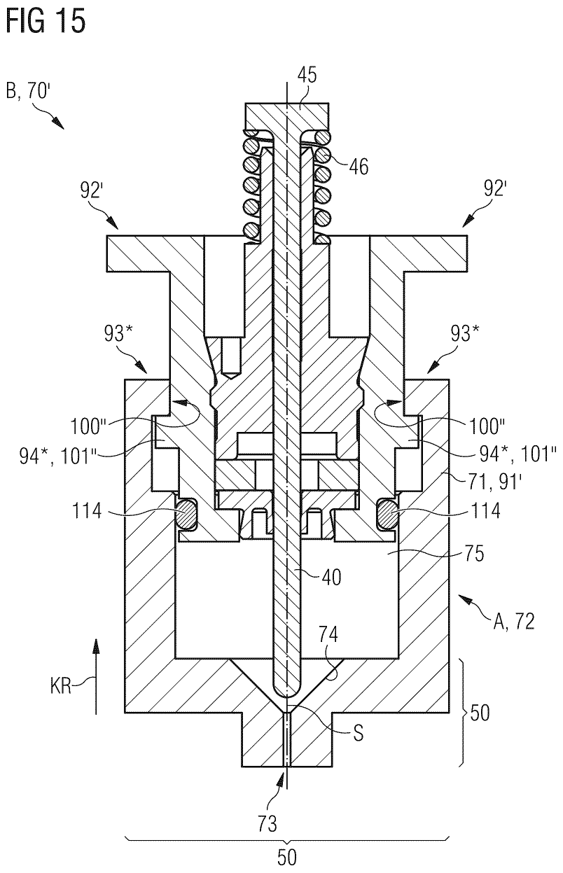

FIG. 15 is a schematic section through parts of a fluidic unit according to the invention,

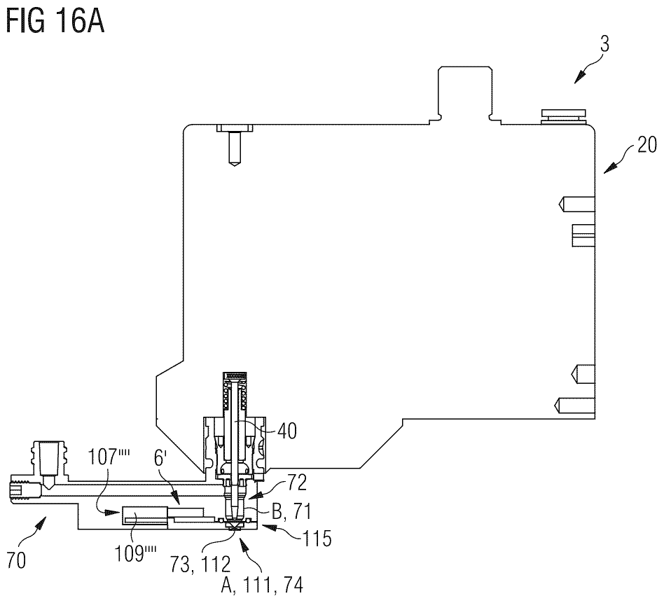

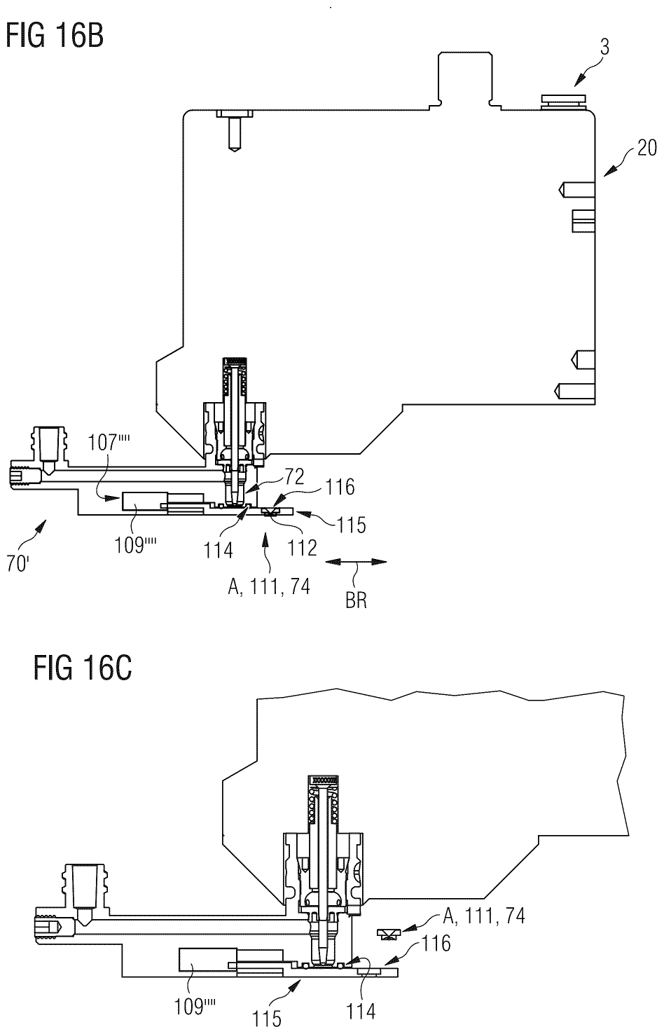

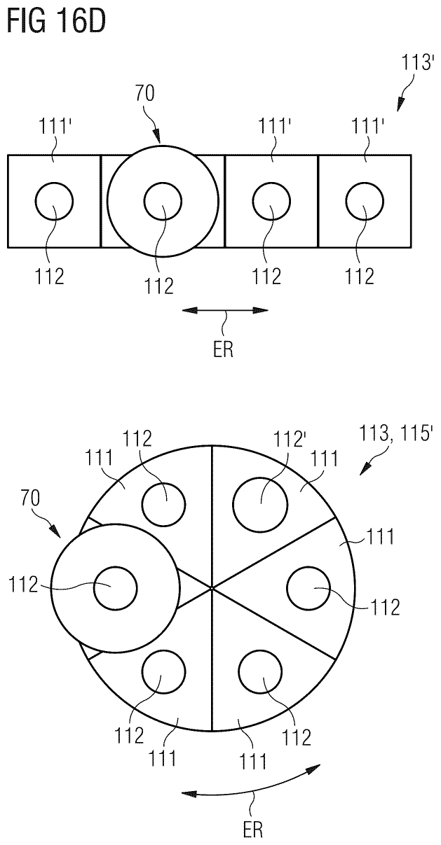

FIG. 16 shows sectional views through parts of a dosing system and schematic views of nozzle apertures according to the invention.

A preferred exemplary embodiment of a dosing installation 1 according to the invention will now be described with reference to FIG. 1. The dosing installation 1 comprises as essential components a dosing device 2 with a plurality of dosing systems 3 as well as a change system 6 and a maintenance device 9. Unlike in the purely schematic representation shown in FIG. 1, a dosing installation 1 can be an entire production facility and can then have two or more dosing devices 2. However, it would also be possible in principle for a dosing installation 1 to have only one dosing device 2 with only a single dosing system 3.

The dosing device 2 in FIG. 1 has five individual dosing systems 3, which are arranged on the dosing device 2 during dosing operation and are in particular detachably connected thereto. The individual dosing systems 3 here each have a fluidic unit 70 and an actuator unit 20 functionally coupled thereto. In the coupled state, the two components 20, 70 each form a dosing head 5. The dosing head 5 here comprises all the components that are actively involved in the dosing material dispensing, in particular mechanically, and accordingly forms a dosing valve 5, wherein the terms dosing head 5 and dosing valve 5 are used synonymously.

The individual dosing heads 5 are each coupled here, for example, in terms of switching or control technology, to a higher-level, decentralized control device 7. Since the control device 7 also has a regulating function here, whereby corresponding electrical signals can be transmitted in both directions between the control device 7 and the dosing heads 5, a flow of data D or control data D is shown symbolically by double arrows.

During operation, the higher-level control device 7 is assigned to several dosing heads 5 simultaneously and can control their dosing operation separately. A respective dosing head 5 and the associated control device 7 as well as a dosing material supply, not shown in detail, each form a dosing system 3. Other than is shown here, each dosing valve 5 could additionally be assigned its own control unit, for example, which can be arranged in a housing of a dosing valve 5, and which controls at least the respective dosing operation. Then the control units of the respective dosing valves 5 or the dosing systems 3 can be implemented as sub-control units that can communicate with each other and/or with a higher-level control device 7 or can also at least partially form one.

The control device 7 is designed in FIG. 1 as a higher-level, external control device 7. For the sake of clarity, the individual dosing systems 3 do not have their own (internal or local) control unit, although in reality this is usually the case. The control device 7 is shown here schematically with two sub-control units, wherein the control device 7, for example, can also be designed in such a way that several sub-control units are arranged at different positions within the dosing system 1 and cooperate to form an (overall) control device 7.

In the lower right area of the dosing device 2 in FIG. 1, a decoupled or partial dosing system is shown schematically, wherein only the actuator unit 20 is arranged on the dosing device 2. For example, an automated change of a dosing head component could be carried out according to the invention on this dosing system or the remaining part thereof. In this example, a fluidic unit 70 as the first dosing head component A (not shown) has been decoupled from the actuator unit 20 as the second dosing head component B.

FIG. 1 on the left shows a change system 6 with a magazine 60 and a change device 61 e.g. a movable change manipulator 61. The change system 6, in particular the magazine 60 and the change manipulator 61, are connected to the control device 7 by means of signal technology and can be controlled via corresponding data D or can also send data D to the control device 7.

The magazine 60 here comprises, for example, two receiving positions for respectively one dosing head component A, 70. Each receiving position in the magazine 60 is assigned a maintenance coupling element 62. The dosing head components A, 70 can be positioned in the magazine 60 such that a supply coupling element 15 of a respective dosing head component A, 70 cooperates with respectively one maintenance coupling element 62 in order to form a maintenance coupling 8 thereabove.

Via the maintenance coupling 8, heating data can be read from an EEPROM of the fluidic unit 70, whereby a signalling connection with the control device 7 is provided via the maintenance coupling. Furthermore, a cleaning fluid can be supplied to a specific dosing head component A, 70 in the magazine 60 via a maintenance coupling 8, which is shown here schematically via a fluid flow FS to a maintenance device 9 arranged here as an example on the magazine 60. For this purpose, a cleaning mechanism is implemented in the maintenance device 9, wherein the maintenance device 9 is also connected to the control device 7 by signal technology and can exchange data D with the latter, e.g. to rinse a specific dosing head component A, 70 in the magazine 60 according to a cleaning program.

FIGS. 2 to 5 show purely schematically parts of different dosing systems 3 with differently designed dosing heads 5.

In FIG. 2, the dosing system 3, as in FIG. 1, consists of a dosing head 5 and an associated control device (not shown) as well as a dosing material supply 130. The dosing head 5 has as its first central component an actuator unit 20 which is mounted on a higher-level dosing device 2. The actuator unit 20 is connected by signal technology to the dosing device 2, in particular to the control device, not shown in detail, as part of the dosing device 2, via control cables 21 in the region of a connection point 17. Via connection points 17′″, which are connected to a cooling medium supply 22′ of the dosing system 3, the actuator unit 20 can, for example, be supplied with a, for example, pre-cooled cooling medium during operation in a controlled and/or regulated manner, in particular by means of a supply device.

A second component of the dosing head 5 is a fluidic system 70, which in FIG. 2 is coupled as intended to the actuator unit 20 to form a functional dosing head 5. The fluidics 70 comprises the media-carrying areas of the dosing head 5 and has, inter alia, a nozzle 72 for dispensing dosing material in an ejection direction SR. This will be described in more detail subsequently by reference to FIG. 6.

In FIG. 2, the fluidics 70 is equipped with a dosing material cartridge 130 that can be carried along during operation as a dosing material supply 130. During dosing operation, the dosing material cartridge 130 is coupled on the one hand to the fluidics 70 and on the other hand is connected to a first interface part 13 via a supply line 82, here a media pressure line 82, in the region of a connection point 17′. The first interface part 13 is designed in several parts in FIG. 2 and comprises two separate and spatially separated interface elements 15, 16, wherein a supply coupling element 15 is shown in FIG. 2 at the top and wherein a functional coupling element 16 is shown in FIG. 2 in the region of the fluidics 70.

In FIG. 2, the media pressure line 82 is connected to the supply coupling element 15 as the first interface element 15 of the first interface part 13. The supply coupling element 15 is further connected in the area of a connection point 17″ to a heating control connection 84, which is in contact with the fluidics 70 via a heating connection cable 83. The heating control connection 84 here comprises a readable EEPROM 85.

The supply coupling element 15 is functionally coupled to a complementary coupling element 18 in the upper region of the dosing system 3, wherein the coupling element 18 is designed here as the first element of the second interface part 14 and is arranged on the dosing device 2.

The supply coupling element 15 of the first interface part 13 and the supply coupling element 18 of the second interface part 14 form a first part of an interface 12, via which a supply coupling 10 is realized. The supply coupling 10 is designed to connect the two supply lines 82, 83 to an external supply device (not shown) during operation of the dosing system 3, wherein the supply device can be implemented, for example, as part of the dosing device 2.

For functional coupling, in the lower area of FIG. 2, the fluidic unit 70 is coupled to the actuator unit 20 via a second part of the same interface 12, wherein a functional coupling 11 is formed via the second partial interface 12. In the case shown here, the fluidics 70 is the first dosing head component A and the actuator unit 20 is the second dosing head component B, which are coupled via the functional coupling 11.

In order to form the functional coupling 11, a functional coupling element 16 is arranged on the fluidics 70 as a second interface element 16 (of the first interface part 13), which functionally cooperates with a complementary functional coupling element 19 of the second interface part 14 on the actuator unit 20.

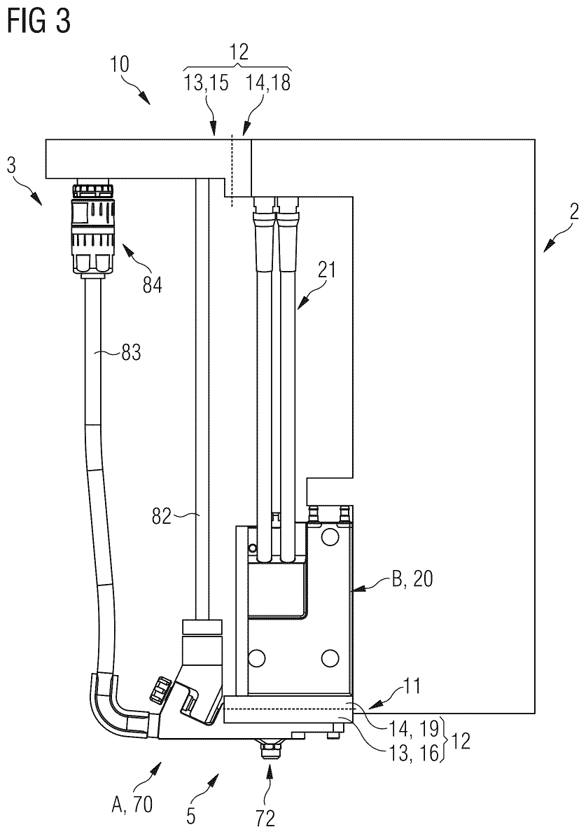

FIG. 3 shows a slightly different embodiment of a dosing head 5, the main difference from FIG. 2 being that the dosing head 5 here does not incorporate dosing material cartridge, but has an external media supply.

The interface 12 in FIG. 3 is again formed in two parts, wherein in the upper area of the dosing system 3 here a supply coupling 10 is formed over a first part of the interface 12. The first interface element 15 of the first interface part 13 is again designed as a supply coupling element 15 and is assigned to the fluidic unit 70. The supply coupling element 15 is connected to a heating control connection 84 and is further connected to a supply line 82, here a media line 82 for a continuous media supply, wherein the dosing material line 82 is formed here as an integral component of the supply coupling element 15.

The supply coupling element 15 comprises a closure coupling (not shown) acting with respect to the dosing material line 82, so that the media-carrying region of the fluidics 70 is closed off from the outside even when the fluidics 70 is decoupled. In the interface 12 shown here, an electrical and a fluid-carrying connection is established between the fluidics 70 and the dosing device 2 or a supply device not shown in detail via the two supply coupling elements 15, 18.

The functional coupling between the fluidic unit 70 (as the first dosing head component A) and the actuator unit 20 (as the second dosing head component B) via a second part of the same interface 12 corresponds to that of FIG. 2 and is described in detail hereinafter by reference to examples, wherein the respective functional couplings 11 can be implemented both in combination with a dosing material supply that can be carried along (FIG. 2) and also in combination with a continuous dosing material supply (FIG. 3).

FIG. 6 shows a part of a dosing system 3 according to one exemplary embodiment of the invention. The dosing system 3 has a dosing head 5 which has a fluidic unit 70 as the first dosing head component A and an actuator unit 20 as the second dosing head component B. The dosing system 3 shown here is a jet valve with a movably mounted ejection element 40. Since the basic structure of such jet valves is known, predominantly the components that are relevant to the invention are described hereinafter.

The actuator unit 20 comprises an actuator housing 22 with a controllable piezo actuator 24 as the working actuator 24. The piezo actuator 24, here a piezo stack, is arranged in an actuator chamber 23 in the housing 22 and is bounded (here above) by a spherical cap 26. On an opposite side, the piezo actuator 24 is mounted on a lever 27 of a movement mechanism 32 via a pressure piece tapering at an acute angle at the bottom and is clamped between the two components 26, 27. The lever 27 in turn rests on a lever bearing 28 at the lower end of the actuator chamber 23. Via this lever bearing 28, the lever 27 can be tilted about a tilting axis K, so that a lever arm of the lever 27 projects through an opening 29 into an action chamber 25 and there projects into an engagement section of a second plug-in coupling part 92, which will be described subsequently.

At the end of the lever arm, this has a contact surface 30 which extends in the direction of an ejection element 40 or plunger 40 of a fluidic unit 70 which can be coupled to the actuator unit 20 and, in the coupled state, rests on a contact surface 45 of a plunger head 44.

The lever 27 is pressed upwards towards the piezo actuator 24 by an actuator spring 31 at the end where it comes into contact with the plunger 40 in order to enable an almost constant pre-stressing of the lever-piezo drive system of the actuator unit 20.

The fluidic unit 70 is shown in FIG. 6 in the decoupled state, e.g. during an automated change process according to the invention. The fluidics 70 here comprises a frame part 81 with a heating device 79 comprising a heating block 80 for controlling the temperature of the dosing material in a feed channel 86 and/or in a nozzle 72 of the fluidics 70. The heating device 79 has heating connection cables 83, which are connected at the end to a heating control connection 84, which in turn is in contact with the supply coupling element of the first interface part (FIG. 2).

The fluidics 70 here has a reservoir connection 78 as part of a reservoir interface 77, in particular for coupling a dosing material cartridge (FIG. 2). The reservoir connection 78 can, for example, have a screw mechanism, merely indicated in FIG. 6, as a second interface part, which in an automated change process cooperates with an internal thread of a dosing cartridge as the first interface part for coupling. In this case, only the cartridge could be specifically replaced, wherein then, other than that shown in FIG. 6, the dosing material cartridge would be the first dosing head component and the fluidics 70 would be the second dosing head component.

Alternatively, the reservoir connection 78, as shown in FIG. 2, can also be designed to change a dosing agent cartridge via a supply coupling 10, i.e. together with the entire fluidics 70, wherein the dosing material cartridge can then be changed manually after the fluidics 70 has been disconnected.

In FIG. 6, a feed channel 86 for dosing material extends from the reservoir interface 77 through the fluidics 70 and opens into a nozzle chamber 75 inside the nozzle 72.

The nozzle 72 here comprises a nozzle casing 76, which surrounds the nozzle chamber 75, and a nozzle opening 73. The nozzle opening 73 has a nozzle insert 74 with an internal conical sealing seat (not shown) tapering towards the nozzle opening 73, into which a tip 41 of the ejection element 40, e.g. a plunger tip 41, can be pressed in a sealing manner, provided that the piezo actuator 24 is expanded. The nozzle chamber 75 is sealed upwards (in the direction of the plunger head 44) via a plunger seal 42 with respect to the action chamber 25 in the coupled state. The plunger seal 42 is adjoined towards the top by a plunger bearing 43 with a pushed-on plunger spring 46, which presses the plunger head 44 from the plunger bearing part 43 in the axial direction upwards away from the nozzle 72 and thus also presses the plunger tip 41 away from the sealing seat. This means that without external pressure from above on the contact surface 45 of the plunger head 44, in the rest position of the spring 46 the plunger tip 41 is in the coupled state at a distance from the sealing seat of the nozzle insert 74 (“normally open” valve).

Characteristically—as in the present invention and regardless of the specific design of the dosing head—in jet valves the dosing material is “actively” ejected from the nozzle 72 by an (ejection) movement of the ejection element 40 relative to the nozzle 72, in particular in an ejection movement direction SR of the ejection element 40. During the ejection process, in particular an ejection tip 41 of the ejection element 40 comes into contact with the dosing material to be dispensed and “presses” or “pushes” the dosing material out of the nozzle 72 of the dosing system due to the (ejection) movement of the ejection element 40 and/or the nozzle 72 (not in FIG. 6). This distinguishes a jetting dosing system from other dispenser systems in which a movement of a closure element merely leads to an opening of the nozzle, whereby a pressurized dosing material then exits the nozzle by itself. This is the case, for example, with injection valves in combustion engines.

The intended coupling of the first with the second dosing head component A, B takes place in FIG. 6 via a plug-in coupling 90 with a first plug-in coupling part 91 and a second plug-in coupling part 92 cooperating therewith. The first plug-in coupling part 91 is designed as part of the fluidic unit 70, wherein the second plug-in coupling part 92 is part of the actuator unit 20. To couple the fluidics 70 to the actuator unit 20, the fluidics 70 can be inserted into the actuator unit 20 in the axial direction along a plug-in axis S with the first plug-in coupling part 91 via a receiving section 104 in the second plug-in coupling part 92, e.g. by means of a movable change manipulator (not shown). This is described in more detail hereinafter with reference to FIG. 7, which shows the first plug-in coupling part 91 on the fluidics 70 enlarged and isolated.

In the example in FIG. 6 and FIG. 7, the first plug-in coupling part 91 has a plurality of radially outwardly extending projections or teeth 100 as a first latching element. In the same way, the second plug-in coupling part 92 or the counter-plug-in coupling part 92 has in its interior matching teeth 101 (as a second latching element) (FIG. 6), which interact with the teeth 100 of the first plug-in coupling part 91 so that the plug-in coupling parts 91, 92 can be coupled together. The design and arrangement of the teeth 100, 101 is selected in such a way that in at least a first rotational position (relative to a rotation about the plug-in axis S) of the first plug-in coupling part 91 and the counter plug-in coupling part 92 with respect to one another, the teeth 100, 101 run past one another when the plug-in coupling parts 91, 92 are inserted into one another. The two plug-in coupling parts 91, 92 can be rotated with respect to one another about the plug-in axis S (second rotational position), so that the teeth 100 of the first plug-in coupling part 91 engage behind the teeth 101 extending inwards in the counter plug-in coupling part 92 and couple the two components 70, 20 to one another. Such a rotation can, for example, be accomplished by means of a change manipulator in the automated change process.

The plug-in coupling 90 in FIG. 6 has an optional eccentric mechanism 120 with an eccentric shaft 122, wherein in a (here) upper section an eccentric spring 121 is arranged on the shaft 122, by means of which the eccentric shaft 122 is pressed away from the piezo actuator 24 in the coupled state. If the two plug-in coupling parts 91, 92 are in a desired coupling position in which the teeth 100, 101 of the bayonet-like coupling mechanism are intermeshed, the eccentric shaft 122 can be rotated about its own axis via an eccentric lever 123, so that a press ball 124 is pressed with relatively high pressure via a through hole against an outer wall of the first plug-in coupling part 91. By this means, a particularly secure fixation of the two dosing head components A, B with respect to one another can be achieved. The eccentric mechanism 120 is shown here only as an example, in which case instead of the lever 123, an automatically controllable actuator can be provided to move the eccentric mechanism 120. For example, the eccentric or the eccentric shaft 122 could be driven by an electric or pneumatic actuator. The basic structure of such a bayonet-type plug-in coupling and a jet valve in general is known, for example, from DE 10 2017 122 034 A1, the content of which is hereby incorporated into this application.

With reference to FIG. 7, some details of the first plug-in coupling part 91 from FIG. 6 are described. The plug-in coupling part 91 has in its (here) lower region a nozzle section 103 which forms an essential part of a nozzle 72. The plug-in coupling part 91 has an external thread 102 via which a nozzle casing section 76 can be screwed on in the manner of a cap nut.

In the area adjoining the nozzle section 103 at the top, the plug-in coupling part 91 has a section that can be inserted into the counter plug-in coupling part 92 of the actuator unit 20, with an optional clamping section 98 initially adjoining the nozzle section 103. The clamping section 98 here has several spherical caps 95 into which a press ball 124 of an optional eccentric mechanism can be pressed, as described with reference to FIG. 6.

Located above the clamping section 98 is a circumferential annular groove 96 for a seal 97, for example, a typical O-ring 97 (see FIG. 6). The seal 97 ensures that the first plug-in coupling part 91 and the second plug-in coupling part 92 are annularly sealed with respect to one another in the coupled state. Located above this annular groove 96 is a bayonet coupling section 99 or toothed section 99, on each end of which a plurality of radially outwardly extending projections 100 or teeth 100 are arranged.

FIG. 8 shows, by way of example and purely schematically, a decoupling of a fluidic unit 70 (as the first dosing head component A) from an actuator unit 20 (as the second dosing head component B), as could be carried out in the automated process. FIG. 8A shows a side view of a (still) complete dosing head 5, wherein a movable change manipulator 61 is shown below the fluidics 70 as part of a change system, which positively engages a coupling region 50 of the fluidics 70 via an access element 57. The coupling region 50 is here predominantly formed on an underside of the fluidics 70 facing away from the actuator unit 20.

FIG. 8B shows the same state of the dosing head 5 from FIG. 8A, but this time as a top view of the actuator unit B, 20. The fluidics A, 70 is rotated by means of the change manipulator 61 from a first rotational position corresponding to a direction of rotation BR for decoupling by a certain angle into a second rotational position. The actuator unit B, 20 is arranged on a dosing device (not shown) to enable rotation of the components 20, 70 with respect to one another.

FIG. 8C shows the components A, B of the dosing head from FIG. 8A in the decoupled state from the side, wherein FIG. 8D shows a top view of the (twisted) decoupled fluidics A, 70. In the side view it can be seen that the change manipulator 61 here has a controllable closing mechanism 63 in order to sealingly close a nozzle opening of a nozzle 72 from the outside during transport.

FIG. 9 shows two sectional views of parts of a dosing system with a plug-in coupling and an enlarged plan view of a latching element. For the sake of clarity, in FIG. 9—as well as in FIGS. 10 to 12—essentially only those parts of the actuator unit 20 and the fluidics 70 which are involved in the formation of the plug-in coupling are shown schematically.

In FIGS. 9A and 9B, the same dosing system 3 is shown in different (coupling) states, wherein in FIG. 9A a first plug-in coupling part 91 of the fluidics 70 is introduced in a coupling direction KR from below into a counter plug-in coupling part 92 in the actuator unit 20, e.g. by means of a change manipulator (not shown). The coupling direction KR or an opposite decoupling direction runs in FIGS. 9 to 12 and 15 parallel to a plug-in axis(S) of the respective plug-in coupling.

The first plug-in coupling part 91 has here, as the first latching element 93, an annular groove 93 running around the base body of the plug-in coupling part 91, with a collar adjoining it upwards in the direction of the plunger head 44.

The second plug-in coupling part 92 has a linearly movable bearing element 94 as a second latching element 94. The plate-like bearing element 94 has a semicircular recess (FIG. 9C) which at least partially encloses the base body of the first plug-in coupling part 91 for coupling. For coupling, the bearing element 94 can at least partially and positively engage around the annular groove 93 in the first plug-in coupling part 91, so that the protruding collar rests on top of the bearing element 94 in the coupled state (FIG. 9B).

The bearing element 94 can be moved linearly in a direction BR by means of a controllable actuator 109, which is part of a locking mechanism 107. The actuator 109 here comprises a pneumatic actuator with an actuator chamber 105 and a piston spring-loaded therein, as well as a controllable pressure medium supply 106 in order to supply the pneumatic actuator chamber 105 via a compressed air channel, for example, with compressed air.

To decouple the two dosing head components A, B, the pneumatic actuator chamber 105 can be pressurized with compressed air so that the bearing element 94 is moved away from the first plug-in coupling part 91, in FIG. 9A according to the direction of movement BR to the right.

For coupling, the pneumatic actuator can be depressurized, whereby the bearing element 94 is moved by means of spring force in the direction BR towards the annular groove 93 in the first plug-in coupling part 91 and at least partially encloses it (FIG. 9B). The bearing element 94 and other parts of the locking mechanism 107 not shown form a kind of sliding mechanism.

FIG. 10 shows another example of a plug-in coupling. The plug-in coupling shown here is similar in terms of its functional principle to the plug-in coupling from FIG. 6, whereby the locking of the two plug-in coupling parts 91, 92 to form a dosing head is implemented differently. FIG. 10A shows a sectional view through parts of a dosing system 3, whilst FIG. 10B shows an enlarged view of parts of a fluidics 70 with a first plug-in coupling part 91 and parts of a second plug-in coupling part 92.

For coupling the two dosing head components A, B, the first plug-in coupling part 91 similar to FIG. 9 is pushed so far from (here) below according to a coupling direction KR into the second plug-in coupling part 92 in the actuator unit 20 until the two plug-in coupling parts 91, 92 and thus also the two dosing head components A, B are positioned relative to each other as intended in order to carry out a coupling.

For locking the two plug-in coupling parts 91, 92, the second plug-in coupling part 92 has a rotary plate 94′ as a second latching element 94′, with a number of intermittent projections 101′ and notches 101*. This is particularly evident in FIG. 10B and shows the different design principle compared to the sliding mechanism from FIG. 9.

The first plug-in coupling part 91 has a number of teeth 100′ as the first latching element 93′, wherein a tooth 100′ is assigned to a recess 101* in the rotary plate 94′ in order to guide the two plug-in coupling parts 91, 92 into one another in order to guide the teeth 100′ in the axial direction in a coupling direction KR (FIG. 10A) from below in the direction of the actuator unit 20 past the rotary plate 94′.

As soon as the two plug-in coupling parts 91, 92 are positioned as intended for coupling, the rotary plate 94′ is rotated by means of a locking mechanism 107′ along a circular path by a certain angle in a direction of rotation BR, so that the teeth 100′ in the first plug-in coupling part 91 and the projections 101′ in the rotary plate 94′ engage one behind the other. As can be seen in FIG. 10B, the teeth 100′ rest “on top” of the projections 101′ of the rotary plate 94′ in the coupled state.

For movement, the second plug-in coupling part 92 comprises a controllable locking mechanism 107′ with an actuator 109′, which here comprises an electric motor 105′ and a gear 105″, wherein the gear 105″ is in operative contact with an external gear ring 106′ (as part of the locking mechanism 107′) on the rotary plate 94′ (FIG. 10B). Since the rotary plate 94′ is involved here both in the locking of the two plug-in coupling parts 91, 92 and is, at least indirectly, in operative contact with the actuator 109′, the same element 94′ can, on the one hand, form a latching element 94′ and, on the other hand, preferably in another area, be part of a locking mechanism 107′.

FIG. 11 shows a further example of a plug-in coupling, wherein here, unlike in FIGS. 6 to 10, the plug-in axis runs essentially orthogonal to an ejection direction SR of dosing material from the nozzle 72 corresponding to a coupling direction KR. FIG. 11A shows a perspective view of an actuator unit B, 20 and a fluidics A, 70 decoupled therefrom. The fluidics 70 has a first plug-in coupling part 91, wherein the first latching element 93″ has two elongated holding elements 51 or two “tongues” 51 that protrude laterally beyond the base body of the plug-in coupling part 91 and are arranged on two opposite sides of the plug-in coupling part 91. This is particularly visible in the longitudinal section through the (here) coupled fluidics 70 in FIG. 11C.

The second plug-in coupling part 92 has, as a second latching element 94″, two elongated recesses 52 or grooves 52 in the actuator unit 20, into which a spring 51 engages in a formfitting manner to form the plug-in coupling when the first plug-in coupling part 91 is inserted laterally into the actuator unit 20 in a coupling direction KR in FIG. 11B. Since two springs 51 are provided here for coupling, the two springs 51 could also be designated as two (first) latching elements 93″, in which case the grooves 52 in the actuator unit 20 would accordingly form two (second) latching elements 94″.

For locking the two plug-in coupling parts 91, 92 in a correct position, the second plug-in coupling part 92 comprises a locking mechanism with a spring-loaded latching pin 108 as a latching element. Other than shown in FIG. 11, the locking mechanism could alternatively or additionally have a controllable actuator, e.g. a pneumatic actuator, via which a locking bolt as a further latching element can be actively moved essentially orthogonally to the coupling direction KR, preferably with a linear movement.

FIG. 12 shows sectional views of parts of a dosing system 3 with another differently designed plug-in coupling in the uncoupled state (FIG. 12A) or in the correctly coupled state (FIG. 12B) of the two dosing head components A, B.

The first plug-in coupling part 91 has a number of spherical caps 95′ as a latching element 93′″ in the upper part of the plug-in coupling part 91. Alternatively, the spherical caps 95′ could also be designed in the form of a circumferential annular groove. The spherical caps 95′ could also each form a latching element 93′″.

The second plug-in coupling part 92 has a plurality of locking balls 54 (only two visible here) as latching elements 94′″, wherein each locking ball 54 is assigned a through-opening 53 in the receiving area of the second plug-in coupling part 92. The second plug-in coupling part 92 comprises a controllable actuator 109″ with a pneumatic actuator chamber 105 and a compressed air supply 106. The pneumatic actuator chamber 105 is realized here by means of an annular channel, wherein under pressure a locking ring 106′″, which is mounted on the balls 54 via springs 106″, is pushed away (here) upwards, so that the balls 54 are no longer pressed into the through-openings 53. In this state shown in FIG. 12A, the plug-in coupling is “open” since the balls 54 have sufficient free space to be pressed into an annular channel 106″, wherein the first plug-in coupling part 91 can be inserted into the actuator unit 20 along a plug-in axis (corresponds to the coupling direction KR) into an intended position such that a spherical cap 95′ and a through-opening 53 are at the same height.

For locking the two dosing head components A, B, the pneumatic actuator is depressurized, whereby the locking ring 106′″, which is wedge-shaped in radial cross-section, presses the locking balls 54 via the springs 106″ via the through-openings 53 into the respectively assigned spherical caps 95′ (FIG. 12B).

FIG. 13 shows purely schematically in cross-section another example of a plug-in coupling, wherein the first latching element 93″″ is realized by means of a number of spherical caps 56.

The second latching element 94″″ comprises a number of through-openings corresponding to the number of spherical caps 56, which for example, can be similar to FIG. 12, wherein in the sectional view only the webs between the respective through-openings or between the locking balls 54 are visible. The second latching element 94″″ has a number of balls 54 corresponding to the number of through-openings and a rotary plate 55′ with intermittent projections 55 and recesses 55″. As shown here, the number of balls 54 corresponds to the number of recesses 55″ in the rotary plate 55′. The second plug-in coupling part 92 has a controllable actuator 109 (as part of a locking mechanism) to actively move the second latching element 94″, in particular the rotary plate 55′, in sections along a circular path in accordance with a direction of rotation BR. For coupling the two plug-in coupling parts 91, 92, the recesses 55″ in the rotary plate 55′ and the through-openings are arranged to match each other as shown here, so that respectively one ball 54 is arranged in a respective recess 55″, wherein the rotary plate 55′ is rotated via the actuator 109 and the resulting rotary movement such that respectively one ball 54 is pressed radially inwards into a spherical cap 56 via a projection 55 of the rotary plate 55′. Although the balls 54 are mounted so as to be movable, they are however held by the stationary through-openings in the second plug-in coupling part 92 and substantially do not perform any rotary movement.

In FIGS. 14 to 16 additional dosing heads or parts thereof are shown schematically according to the invention, whereby here—in contrast to FIGS. 6 to 13—a specific nozzle element as a first dosing head component is detachably coupled to a fluidic base body or to the (same) nozzle via an interface, i.e. that at least some parts of the fluidics, in particular the fluidic base body, are coupled to the actuator unit during the change process.

In FIG. 14, the component A to be replaced is a nozzle casing 76 which has an internal thread as the first interface part, such as shown in FIG. 14B for example. A complementary second interface part is arranged on (the same) nozzle, here by means of an external thread on the nozzle base body 71 which is not to be replaced, as a second dosing head component B (FIG. 14B). In this case, a dosing head is therefore formed by coupling a first nozzle part A, 76 with another nozzle part B, 71 to form a nozzle 72 via an interface. Whereas in FIG. 14A the nozzle casing 76 is still coupled to the fluidic base body, over which a fluidics 70 is formed, FIG. 14B shows a decoupled nozzle casing A, 76, wherein a fluidic base body 70′ with a nozzle base body B, 71 remains on the actuator unit 20.

For replacement, the first dosing head component A has a coupling region 50, which is realized here by means of a special external shape of the nozzle casing 76, e.g. a basic shape with a hexagonal cross-section. This can be seen, for example, in FIG. 14C, wherein a change system 6 has a nozzle holder 58 complementary to the coupling region 50, i.e. to the outer shape of the nozzle casing 76, into which the coupling region 50 can engage in a form-fitting manner.

The change system 6 comprises a locking mechanism 107″ with a controllable actuator 109′″, e.g. an electric motor to actively rotate the hexagonal nozzle holder 58 with respect to the nozzle body B, 71 for coupling or decoupling in different directions (FIG. 14A). The nozzle holder 58 is connected to the actuator 109′″ via a rotating mechanism 64 (as part of the locking mechanism 107″). The respective nozzle holders 58 remain in the change system 6 even after a change.

In the example in FIG. 14, the locking mechanism 107′″ is designed as a component of a magazine 60 of the change system 6. FIG. 14C shows, by way of example, a magazine 60 with five sub-units 60′, each having a receiving position for a nozzle casing 76, wherein each sub-unit 60′ has a separate locking mechanism. In this example, to change components, either the dosing system 3 can be moved to the magazine 60 or vice versa, although in principle a combination is also conceivable.

Other than is shown here, it would also be possible for the nozzle casing 76 to be exchanged via a movable change manipulator, e.g. by the change manipulator actively moving two or more sub-units 60′ to the dosing system 3 in order to suitably position a specific nozzle casing A, 76 for coupling with respect to the nozzle base body B, 71.

FIG. 15 shows a further example of a dosing system according to the invention in section and schematically, wherein here an entire nozzle 72 as the first dosing head component A is coupled to a (remaining) fluidic unit, i.e. to a fluidic base body 70′, as the second dosing head component B, in order to form a dosing head thereon.

In FIG. 15, the fluidics are configured in “two parts” in the manner of a plug-in coupling and comprise a first plug-in coupling part 91′, which is formed here by means of a nozzle base body 71, and a fluidic base body 70′, which is only partially shown. The plug-in coupling can have a similar functionality as explained in FIG. 6. Accordingly, the first plug-in coupling part 91′ has a first latching element 93* with a number of teeth 100 at the (here) upper end of the nozzle base body 71.

The second plug-in coupling part 92′ is configured here as part of the (remaining) fluidics, i.e. as a fluidic base body 70′, and has a second latching element 94* with a number of teeth 101″. For coupling, the first plug-in coupling part 91′ can be inserted into the second plug-in coupling part 92′ in a direction KR, wherein the first latching element 93* and the second latching element 94* can be twisted with respect to one another about the plug-in axis S as described with reference to FIG. 6, e.g. by means of a change manipulator. The coupling region 50 for the change manipulator (not shown) corresponds here, for example, to an underside comprising the nozzle opening 73 and a lateral region of the nozzle base body 71. A sliding seal 114 is arranged between the first and the second plug-in coupling part 91′, 92′.

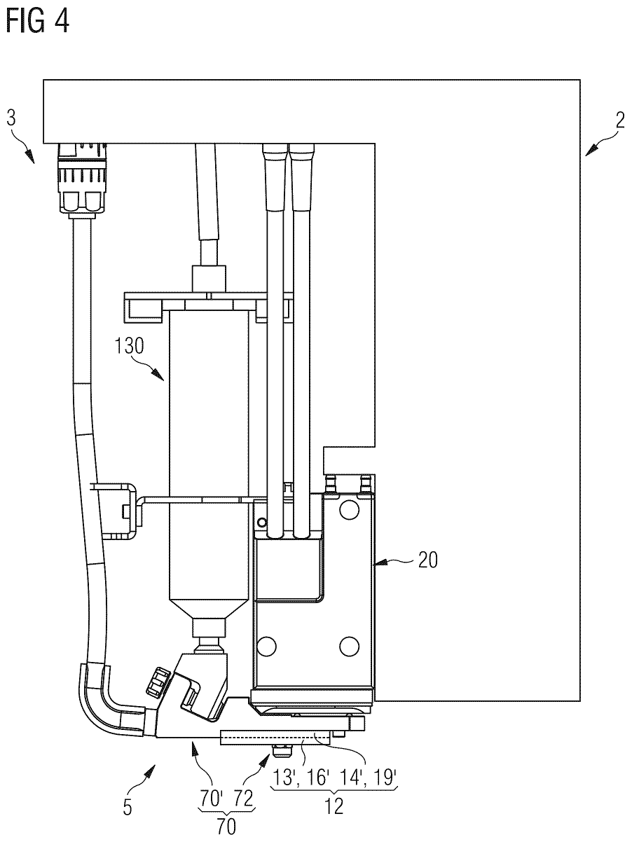

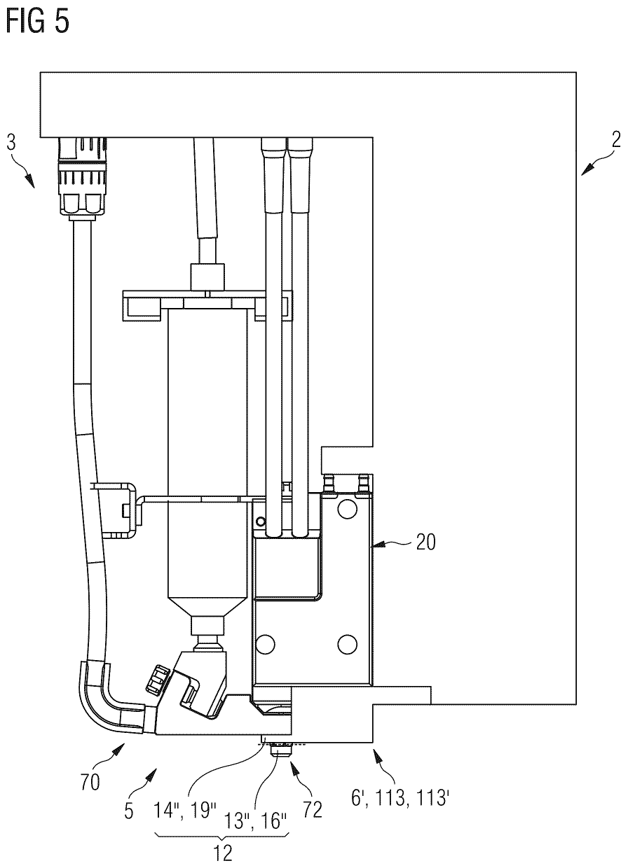

A dosing system 3 previously partially described with reference to FIG. 15 is shown purely schematically in FIG. 4 with an associated dosing device 2. In the example shown, an interface 12 is formed via a first interface part 13′ with a first functional coupling element 16′ and a second interface part 14′ with a second functional coupling element 19′. The first functional coupling element 16′ is the first plug-in coupling part 91′ described with reference to FIG. 15, wherein the second functional coupling element 19′ corresponds to the counter plug-in coupling part 92′ on the fluidic base body 70′. As shown in FIG. 4, the fluidic base body 70′ and a nozzle 72 coupled thereto as intended form the fluidics 70. In the example in FIG. 4, the interface 12 is-unlike for example in FIG. 2-formed in one piece. In this case, no separate supply coupling element is required on the first or second interface part to form the dosing head 5.

FIG. 16 schematically shows a further example of a dosing system according to the invention, wherein a first dosing head component A is designed in the form of a nozzle aperture 111 and a second dosing head component B is designed as part of a nozzle base body 71.

In FIGS. 16A and 16B, parts of a fluidics 70 or a fluidic base body 70′ are shown in section, wherein the fluidics 70 or the fluidic base body 70′ comprises a locking mechanism 107″″ with a controllable actuator 109″″ and a slider 115, here a bearing part 115, which form an integrated linear drive. In this embodiment, the locking mechanism 107″″ with the sub-components 109″″, 115 forms the change system, in this case an aperture change system 6′. The slider 115 (as part of the change system) has a nozzle aperture holder 116 for a nozzle aperture A, 111 (as the first dosing head component A) and is here firmly connected to the actuator 109″″. The slider 115, and above it also the nozzle aperture 111, can be moved horizontally for coupling or decoupling of the nozzle aperture 111 in one direction BR.

In the embodiment shown in FIGS. 16A and 16B, the nozzle aperture 111 is realized as a nozzle insert 74, which is held in a separately formed bearing part 115 for coupling and/or decoupling and during operation of the dosing system 3, which bearing part 115 here simultaneously has the function of a slider 115. The nozzle insert 74, i.e. the nozzle aperture 111, forms the outer lower end of the nozzle 72 in the coupled state and delimits a nozzle chamber at the bottom.

The bearing part 115 has a nozzle aperture holder 116 in which a specific nozzle aperture 111 positively engages (FIG. 16C). In the case shown here, an outer contour of the nozzle aperture 111, via which the nozzle aperture 111 has contact with the bearing part 115, is a coupling region of the nozzle aperture 111 for the automated change, wherein the change is carried out via the aperture change system 6′.

In FIG. 16A, the nozzle aperture A, 111 is coupled as intended to the nozzle base body B, 71 to form a dosing head, wherein a nozzle aperture opening 112, which forms the nozzle opening 73 of the dosing system 3, is arranged centred with respect to a plunger tip. In this example, the nozzle aperture 111 is arranged on the nozzle 72 in such a way that the nozzle aperture 111 forms an attachment of the nozzle 72 and abuts against the nozzle 72, in particular the nozzle base body B, 71, in a fluid-tight manner from below on the outside.

For decoupling, the slider 115 can be moved to the right here by means of the locking mechanism 107″ so that the nozzle aperture 111, in particular the nozzle aperture opening 112, is pushed laterally away from the nozzle 72. For this purpose, the plunger must first be moved away from the nozzle aperture 112 and preferably a dosing material cartridge must be depressurized or the dosing material supply interrupted. A sliding seal 114 (here as part of the second interface part) abuts sealingly against the bearing part 115 to enable the change process and to prevent leakage of dosing material during the change. In the example shown here, the bearing part 115 is on the one hand part of the aperture change system 6′ and on the other hand forms a part of a first interface part, e.g. via the interaction with the sliding seal 114.

In FIG. 16B, the nozzle aperture A, 111 is decoupled and has been pushed away from the nozzle 72 to the side or is located outside the dosing valve 3, whereby the fluidic base body 70′ remains on the actuator unit 20. In this decoupled state, the nozzle aperture A, 111 can be removed upwards from the bearing part 115, in particular from the nozzle aperture holder 116, e.g. by means of a change manipulator, not shown here and be transferred to a cleaning bath for example. Afterwards, for example, by means of the same change manipulator, a “new” nozzle aperture A, 111 can be inserted from above into the then free nozzle aperture holder 116. Subsequently, the slider 115 can be moved in a direction BR, here to the left, to couple the nozzle aperture A, 111 onto the nozzle base body B, 71 again or can be arranged on it here from below. The slider 115 itself remains on the dosing system 3 during the change process.

Other than shown in FIGS. 16A and 16B, an aperture change system 6′ may include a nozzle aperture magazine 113, 113′, as shown schematically in FIG. 5. The aperture change system 6′ with the nozzle aperture magazine 113, 113′ is arranged here as an example on the actuator unit 20 and could also be arranged on the fluidics 70. In FIG. 5 it is clear that in this example both a first interface part 13″ with a first functional coupling element 16″ and a second interface part 14″ with a second functional coupling element 19″ are arranged on the same nozzle 72 to form an interface 12.

In the example from FIG. 5 or FIG. 16, the first interface part or the first functional coupling element is realized by means of the nozzle aperture 111 itself, e.g. by means of the condition of the outer surface and, if necessary, a sliding seal. As previously described, a bearing part 115 may be involved in the formation of the first interface part. The second interface part or the second functional coupling element is realized via the configuration of a receiving area in the nozzle base body 71, e.g. whereby the nozzle casing 111 can be inserted precisely into a slot in the base body 71 and/or is held thereon as intended during operation by the base body 71 and/or a locking mechanism 107″″, e.g. via the bearing part 115, as well as by a sliding seal 114.

The nozzle aperture magazine 113 of FIG. 5 can be designed to store a plurality of separate nozzle apertures 111. However, it is also possible that the nozzle aperture magazine 113′ is realized in the form of a nozzle aperture assembly 113′ with a plurality of nozzle apertures 111′. This is shown in FIG. 16D above, where here a strip-like nozzle aperture assembly 113′ with a plurality of nozzle apertures 111′ is shown, wherein each nozzle aperture 111′ has one nozzle aperture opening 112.

Depending on the configuration, a specific nozzle aperture 111′ can be removed from the magazine 113′ via a locking mechanism 107″, e.g. similar to FIG. 16A, into the nozzle 72 or the nozzle base body B, 71, whereby, for example, the nozzle aperture strip 113′ is moved more linearly in an (introduction) direction ER.

In FIG. 16D, another nozzle aperture magazine 113 is shown at the bottom, which is realized by means of a bearing part 115′ and a number of nozzle aperture holders 116 (FIG. 16B), wherein a nozzle aperture 111 is arranged in each nozzle aperture holder 116. The nozzle apertures 111 can be removed from the bearing part 115′, for example, in the automated process. As shown in FIG. 16D (bottom), the nozzle aperture openings 112, 112′ of the nozzle apertures 111 in the same magazine 113 or in the same nozzle aperture assembly 113′ can have different designs. Accordingly, the bearing part 115′ can be positioned via the controllable locking mechanism 107″″ and a corresponding twisting of the bearing part 115′, e.g. along a circular path or in an insertion direction ER, with respect to the nozzle base body B, 71 so that a certain nozzle aperture 111 or a certain nozzle aperture opening 112, 112′ is inserted into the nozzle base body B, 71 for coupling or arranged thereon, in particular so that a tip of the plunger 40 and a certain nozzle aperture opening 112, 112′ are concentric to one another during operation. By this means, a desired dosing pattern can be set during operation in the automated change process, whereby in this embodiment a nozzle aperture 111 can also be changed without an external change manipulator, since the magazine 113 or the bearing part 115′ comprises a plurality of different nozzle apertures 111.

Finally, it is pointed out once again that the dosing heads and dosing systems described in detail hereinbefore are merely exemplary embodiments which can be modified in various ways by a person skilled in the art without departing from the scope of the invention. For example, a first or second latching element can also have two or more separately formed latching elements or partial latching elements. Furthermore, a latching element, e.g. a rotary plate, can at least partially also be designed as part of a locking mechanism, in particular if the rotary plate is in operative contact with an actuator. Furthermore, the use of the indefinite articles “a” or “an” does not exclude the possibility that the relevant features may also be present more than once.

### Reference list

1 Dosing installation
2 Dosing device
3 Dosing system
5 Dosing head/dosing valve
6 Change system
6′ Aperture change system
7 Control device
8 Maintenance coupling
9 Maintenance device
10 Supply coupling
11 Functional coupling
12 Interface
13, 13′, 13″ First interface part
14, 14′, 14″ Second interface part
15 Supply coupling element (first interface part)
16, 16′, 16″ Functional coupling element (first interface part)
17, 17′, 17″, 17′″ Connection point
18 Supply coupling element (second interface part)
19, 19′, 19″ Functional coupling element (second interface part)
20 Actuator unit
21 Control cable
22 Actuator housing
22′ Cooling medium supply
23 Actuator chamber
24 Actuator/Piezo actuator
25 Action Chamber
26 Spherical cap
27 Lever
28 Lever bearing
29 Opening
30 Contact surface (lever)
31 Actuator spring
32 Movement mechanism
40 Ejection element/plunger
41 Plunger tip
42 Plunger seal
43 Plunger bearing
44 Plunger head
45 Contact surface (plunger)
46 Plunger spring
50 Coupling region
51 Tongue
52 Groove
53 Through-opening
54 Locking ball
55 Projection
55′ Rotary plate
55″ Recess
56 Spherical cap
57 Access element
58 Nozzle holder
60 Magazine
60′ Sub-units
61 Change device/change manipulator
62 Maintenance coupling element
63 Locking mechanism
64 Rotating mechanism
70 Fluidic unit
70′ Fluidics base body
72 Nozzle
73 Nozzle opening
74 Nozzle insert
75 Nozzle chamber
76 Nozzle casing
77 Reservoir interface
78 Reservoir connection
79 Heating device
80 Heating block
81 Frame part
82 Media pressure line/media line
83 Heating connection cable
84 Heating control connection
85 EEPROM
86 Feed channel
90 Plug-in coupling
91, 91′ First plug-in coupling part
92, 92′ Second plug-in coupling part
93, 93′, 93″, 93′″, 93″″, 93* First latching element
94, 94′, 94″, 94′″, 94″″, 94* Second latching element
95, 95′ Spherical cap
96 Ring groove
97 Seal (O-ring)
98 Clamping section
99 Gear section
100, 100′, 100″ Teeth (first plug-in coupling part)
101, 101′, 101″ Teeth (second plug-in coupling part)
101* Notch (second plug-in coupling part)
102 External thread
103 Nozzle section
104 Receiving section
105 Pneumatic actuator chamber
105′ Electric motor
105″ Gear
106 Pressure medium supply
106′ Gear ring
106″ Springs
106′″ Locking ring
106″″ Ring channel
107, 107′, 107″, 107′″, 107″″ Locking mechanism
108 Latching pin
109, 109′, 109″, 109′″, 109″″ Actuator
111, 111′ Nozzle aperture
112, 112′ Nozzle aperture opening
113, 113′ Nozzle aperture magazine/nozzle aperture assembly
114 Sliding seal
115, 115′ Bearing part/slider
116 Nozzle aperture holder
120 Eccentric mechanism
121 Eccentric spring
122 Eccentric shaft
123 Eccentric lever
124 Press ball
130 Dosing material supply/dosing material cartridge
A First dosing head component
B Second dosing head component
D Data/Control data
BR Direction of movement/direction of rotation
KR Coupling direction
ER Insertion direction
FS Fluid flow
K Tilting axis
S Plug-in axis
SR Discharge direction of dosing material/Discharge movement direction of discharge element

1. Dosing installation (1) comprising at least one dosing device (2), which dosing device (2) has at least one dosing system (3) comprising at least one dosing head (5) for dispensing a dosing material and at least one change system (6, 6′) assigned to the dosing device (2), wherein the dosing device (2) and/or the change system (6, 6′) and/or the dosing system (3) are designed and can be controlled by a control device (7) in such a way that, in order to form a dosing head (5), at least one first dosing head component (A) can be detachably coupled to at least one second dosing head component (B) in an automated process via the change system (6, 6′).

2. Dosing installation according to claim 1, wherein the change system (6, 6′) has at least one magazine (60, 60′, 113, 113′) for at least one first dosing head component (A) and wherein preferably
the magazine (60, 60′) is arranged in a stationary manner in the dosing installation (1) and wherein the dosing device (2) is designed to be movable and can be controlled by a control device (7) such that a second dosing head component (B) on the dosing device (2) is brought into operative contact with a first dosing head component (A) in the magazine (60, 60′) in an automated process for coupling the dosing head components (A, B) and/or in such a way that a first dosing head component (A) of a dosing head (5) is deposited in the magazine (60, 60′) in an automated process and/or
the magazine (60, 60′) is designed to be movable in relation to the dosing device (2) and can be controlled by a control device (7) such that a first dosing head component (A) in the magazine (60, 60′) is brought into operative contact with a second dosing head component (B) on the dosing device (2) in an automated process for coupling the dosing head components (A, B) and/or in such a way that a first dosing head component (A) of a dosing head (5) is deposited in the magazine (60, 60′) in an automated process and/or
the change system (6) has a movable change device (61) which is designed and can be controlled by a control device (7) such that the change device (61) carries out a transfer of at least a first dosing head component (A) between the magazine (60, 60′) and a dosing device (2) in an automated process, in particular such that a first dosing head component (A) from the magazine (60, 60′) is brought into operative contact with a second dosing head component (B) on a dosing device (2) for coupling and/or such that a first dosing head component (A) is transferred from a dosing device (2) into the magazine (60, 60′).

3. Dosing installation according to claim 2, wherein the magazine (60) of the change system (6) has at least one maintenance coupling element (62) which cooperates with a coupling element (15), preferably a supply coupling element (15), of a first dosing head component (A) to form a maintenance coupling (8), wherein the maintenance coupling (8) is designed to connect at least one supply line (82, 83) of a dosing head component (A) to a maintenance device (9), wherein preferably via the maintenance coupling (8) a cleaner can be introduced into the dosing head component (A) and/or a heating device (79) of the dosing head component (A) can be controlled and/or a memory (85) assigned to the dosing head component (A) can be read out.

4. Dosing installation according to claim 2, wherein the magazine (60, 60′, 113, 113′) of the change system (6, 6′) is designed to store different designs of dosing head components (A), in particular simultaneously, and/or wherein the change system (6, 6′) is designed and can be controlled by a control device (7) such that a specific dosing head component (A) from the magazine (60, 60′, 113, 113′) is brought into operative contact with a second dosing head component (B) on the dosing device (2) for coupling the dosing head components (A, B).

5. Change system (6, 6′) for a dosing installation (1), in particular for a dosing installation (1) according to claim 1, wherein the dosing installation (1) has at least one dosing device (2) with at least one dosing system (3), which dosing system (3) has at least one dosing head (5), wherein the change system (6, 6′) is designed and can be controlled by a control device (7) such that in order to form a dosing head (5), at least one first dosing head component (A) can be detachably coupled to at least one second dosing head component (B) via the change system (6, 6′) in an automated process.

6. Dosing device (2) for a dosing installation (1), in particular for a dosing installation (1) according to claim 1, wherein the dosing device (2) has at least one dosing system (3) with at least one dosing head (5) and wherein the dosing device (2) is designed and can be controlled by a control device (7) such that to form a dosing head (5), at least one first dosing head component (A) can be detachably coupled to at least one second dosing head component (B) in an automated process via a change system (6, 6′) of the dosing installation (1).

7. Dosing head (5) for a dosing system (3), in particular for a dosing installation (1) according to claim 1, which dosing head (5) has at least an actuator unit (20) and a fluidic unit (70) detachably coupled thereto, and
wherein at least one first dosing head component (A) is assigned a first interface part (13, 13′, 13″) of an interface (12),
wherein at least one second dosing head component (B) is assigned a second interface part (14, 14′, 14″) of the interface (12),
wherein the first interface part (13, 13′, 13″) and/or the second interface part (14, 14′, 14″) are designed to detachably couple the first dosing head component (A) to the second dosing head component (B) in an automated process to form the dosing head (5) and
wherein the first dosing head component (A) has a coupling region (50) which is designed to interact with a change system (6, 6′) at least temporarily assigned to the dosing head (5) for coupling the dosing head components (A, B) in the automated process.

8. Dosing head according to claim 7, wherein a first dosing head component (A) comprises at least one of the following elements:
a fluidic unit (70),
a fluidic base body (70′),
a nozzle (72),
a nozzle base body (71),
a nozzle element (76, 111, 111′),
a dosing material supply (130),
and/or wherein a second dosing head component (B) comprises at least one of the following elements:
an actuator unit (20),
a fluidic unit (70),
a fluidic base body (70′),
a nozzle base body (71).

9. Dosing head according to claim 7, wherein the first interface part (13) assigned to the first dosing head component (A) and/or the second interface part (14) assigned to the second dosing head component (B) is formed in several parts.

10. Dosing head according to claim 7,
wherein the first interface part (13) is assigned to the fluidic unit (70) and/or
wherein the first interface part (13) has a supply coupling element (15) for forming a supply coupling (10), wherein the supply coupling element (15) is designed to couple at least one supply line (82, 83) of the fluidic unit (70) to a supply device (2) during operation of the dosing head (5) and/or wherein the supply coupling element (15) comprises a closing mechanism which is designed to close at least one supply line (82) leading to the fluidic unit (70) in a gas-tight and/or liquid-tight manner and/or
wherein the first interface part (13) has a first functional coupling element (16) and wherein a second interface part (14) with a second functional coupling element (19) is assigned to the actuator unit (20) to form a functional coupling (11), and wherein the first interface part (13) and/or the second interface part (14) are designed to detachably couple the fluidic unit (70) to the actuator unit (20) via an interaction between the first and the second functional coupling element (16, 19).

11. Dosing head according to claim 10, wherein the functional coupling element (16) of the first interface part (13) has a first plug-in coupling part (91) and the functional coupling element (19) of the second interface part (14) has a second plug-in coupling part (92), wherein the first plug-in coupling part (91) and the second plug-in coupling part (92) can be plugged into one another along a plug-in axis(S) and coupled to one another integrally for coupling the fluidic unit (70) to the actuator unit (20), and wherein for coupling at least one first latching element (93, 93′, 93″, 93′″, 93″″) is arranged on the first plug-in coupling part (91) and/or at least one second latching element (94, 94′, 94″, 94′″, 94″″) is arranged on the second plug-in coupling part (92), wherein preferably the fluidic unit (70) can be coupled to the actuator unit (20) under at least two rotational positions around the plug-in axis(S) via a coupling region (50) for the change system (6).

12. Dosing head according to claim 11, wherein the first plug-in coupling part (91) and/or the second plug-in coupling part (92), preferably at least the second plug-in coupling part (92), has an automatically movable locking mechanism (107, 107′, 107″) and wherein the locking mechanism (107, 107′, 107″) is designed to move at least one latching element (94, 94′, 94′″, 94″″) in a plug-in coupling part (92) relative to an associated latching element (93, 93′, 93′″, 93″″) in the respective other plug-in coupling part (91) for coupling the fluidic unit (70) to the actuator unit (20).

13. Dosing head according to claim 12, wherein the locking mechanism (107) is designed to move a first latching element and/or a second latching element (94) substantially linearly in at least one direction and/or
wherein the locking mechanism (107′) is designed to move a first latching element and/or a second latching element (94′) at least in sections along a circular path and/or wherein the locking mechanism (107, 107′, 107″) has at least one controllable actuator (109, 109′, 109″) for moving at least one latching element (94, 94′, 94′″, 94″″).

14. Dosing head according to claim 7, wherein a first interface part (13′) with a first functional coupling element (16′) is assigned to the nozzle (72) of the dosing head (5) and wherein a second interface part (14′) with a second functional coupling element (19′) is assigned to the fluidic base body (70′) and/or the nozzle (72), and wherein the first interface part (13′) and/or the second interface part (14′) are designed to detachably couple at least one nozzle element (72, 76, 111, 111′) to the actuator unit (20) and/or to the fluidic base body (70′) and/or to the nozzle (72) via an interaction between the first and the second functional coupling element (16′, 19′).

15. Dosing head according to claim 14, wherein the functional coupling element (16′) of the first interface part (13′) has a first plug-in coupling part (91′) and the functional coupling element (19′) of the second interface part (14′) has a second plug-in coupling part (92′), wherein the first plug-in coupling part (91′) and the second plug-in coupling part (92′) can be plugged into one another along a plug-in axis(S) and coupled to one another integrally for coupling at least one nozzle element (72) to the fluidic base body (70′), and wherein for coupling at least one first latching element (93*) on the first plug-in coupling part (91′) and/or at least one second latching element (94*) is arranged on the second plug-in coupling part (92′), wherein preferably the first plug-in coupling part (91′) can be coupled to the second plug-in coupling part (92′) under at least two rotational positions around the plug-in axis(S) via a coupling region (50) for the change system (6).

16. Dosing head according to claim 14, wherein the nozzle element (111, 111′) comprises a nozzle aperture (111, 111′) and wherein the nozzle aperture (111, 111′) can be introduced into the nozzle (72) in an automated process by means of an aperture change system (6′) which is designed as a component of a change system (6), wherein an introduction direction (ER) of the nozzle aperture (111, 111′) into the nozzle (72) via the aperture change system (6′) is transverse to an ejection direction (SR) of dosing material, in particular transverse to an ejection movement direction (SR) of an ejection element (40).

17. Dosing head according to claim 16, wherein the aperture change system (6′) is preferably detachably connected to the fluidic unit (70) and/or to the actuator unit (20) and/or to a dosing device (2),
and/or wherein the aperture change system (6′) has an automatically movable locking mechanism (107″″) which is designed to introduce a nozzle aperture (111, 111′), preferably by means of a linear movement and/or along a circular path, into the nozzle (72), wherein at least a first functional coupling element and/or a second functional coupling element has a sliding seal (114).

18. Dosing head according to claim 16, wherein the aperture change system (6′) has a nozzle aperture magazine (113, 113′) for at least one nozzle aperture (111, 111′), preferably for a plurality of nozzle apertures (111, 111′), wherein preferably at least two nozzle apertures (111, 111′) have different designs, and wherein the aperture change system (6′) can be controlled and is designed to introduce a specific nozzle aperture (111, 111′), in particular with a specific nozzle aperture opening (112, 112′), into the nozzle (72).

19. Dosing head according to claim 7, wherein a first interface part with at least one first functional coupling element is assigned to a dosing material supply (130) and wherein a second interface part with a second functional coupling element is assigned to the fluidic unit (70), and wherein the first interface part and/or the second interface part are designed to detachably couple at least the dosing material supply (130) to the fluidic unit (70) via an interaction between the first and the second functional coupling element.

20. Dosing system (3) for a dosing device (2) of a dosing installation (1), wherein the dosing system (3) has at least one dosing head (5), in particular a dosing head (5) according to claim 7, wherein the dosing system (3) is designed and can be controlled by a control device (7) such that, in order to form the dosing head (5) of the dosing system (3), at least one first dosing head component (A) can be detachably coupled to at least one second dosing head component (B) in an automated process via a change system (6, 6′) of the dosing installation (1).

21. Method for the automated coupling of at least a first dosing head component (A) with a second dosing head component (B) to form a dosing head (5) of a dosing system (3), preferably a dosing system (3) for a dosing installation (1) according to claim 1, wherein the automated coupling preferably comprises at least one change of a dosing head component (A) and/or takes place during operation of a dosing installation (1), wherein the method comprises at least the following steps:
providing at least one first dosing head component (A) to which a first interface part (13, 13′, 13″) is assigned, preferably by means of a change system (6, 6′),
bringing together, using the change system (6, 6′), the first interface part (13, 13′, 13″), which is assigned to the first dosing head component (A), with a second interface part (14, 14′, 14″), which is assigned to a second dosing head component (B), to form an interface (12),
engaging at least one interface element (10, 11) of the interface (12), preferably by means of a control device (7), in order to detachably couple the first dosing head component (A) via the first interface part (13, 13′, 13″) to the second interface part (14, 14′, 14″) of the second dosing head component (B) to form the dosing head (5),
optional adjustment of an actuator (24) of an actuator unit (20) such that in a defined operating state of the actuator (24), in particular in a deflected operating state, a certain contact force of an ejection element (40) in a nozzle (72) is generated by the actuator (24), wherein the adjustment process is preferably controlled by means of a control device (7).
